(19) United States
(12) Patent Application Publication
(10) Pub. No.: US 2026/0172306 A1
(43) Pub. Date: Jun. 18, 2026

(54) ADVANCED NOTIFICATION OF CRITICAL UPDATES

(71) Applicant: QUALCOMM Incorporated, San Diego, CA (US)

(72) Inventors: Gaurang NAIK, San Diego, CA (US); Abhishek Pramod PATIL, San Diego, CA (US); Youhan KIM, Saratoga, CA (US); Naveen Kumar KAKANI, Flower Mound, TX (US); Vikram PHOGAT, FREMONT, CA (US); George CHERIAN, San Diego, CA (US); Alfred ASTERJADHI, San Diego, CA (US); Sai Yiu Duncan HO, San Diego, CA (US); Sanket Sanjay KALAMKAR, San Diego, CA (US); Sherief HELWA, San Diego, CA (US); Giovanni CHISCI, San Diego, CA (US)

(21) Appl. No.: 18/984,742

(22) Filed: Dec. 17, 2024

(51) Int. Cl. H04L 41/0686; H04L 41/082

(52) U.S. Cl. CPC H04L 41/0686; H04L 41/082

(57) ABSTRACT

This disclosure provides methods, components, devices and systems for advanced notification of critical updates. Some aspects more specifically relate to transmission of an indication of a critical update at least a threshold duration prior to the critical update occurring, where the indication of the critical update includes a time at which the critical update is to occur. In some implementations, the time at which the critical update is to occur may be indicated via a difference between a time at which the indication of the critical update is received and the time at which the critical update is to occur, via a quantity of beacon intervals, via an absolute time reference, or any combination thereof. Additionally, or alternatively, the indication of the critical update may include an indication of one or more communication links for which the critical update applies, additional information about the critical update, or both.

### TECHNICAL FIELD

This disclosure relates generally to wireless communication and, more specifically, to advanced notification of critical updates.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a first wireless device for wireless communications is described. The first wireless device may include a processing system that includes processor circuitry and memory circuitry that stores code. The processing system may be configured to cause the first wireless device to transmit an indication of an update to one or more parameters, at least a threshold duration prior to the update, associated with one or more features, one or more generations of a wireless network, one or more modes of operation, or any combination thereof, where the indication of the update includes an indication of a time at which the update is to occur relative to a reference point and communicate with a second wireless device in accordance with the update to the one or more parameters after the time at which the update is to occur.

Another innovative aspect of the subject matter described in this disclosure can be implemented in a method for wireless communications by a first wireless device is described. The method may include transmitting an indication of an update to one or more parameters, at least a threshold duration prior to the update, associated with one or more features, one or more generations of a wireless network, one or more modes of operation, or any combination thereof, where the indication of the update includes an indication of a time at which the update is to occur relative to a reference point and communicating with a second wireless device in accordance with the update to the one or more parameters after the time at which the update is to occur.

Another innovative aspect of the subject matter described in this disclosure can be implemented in another first wireless device for wireless communications is described. The first wireless device may include means for transmitting an indication of an update to one or more parameters, at least a threshold duration prior to the update, associated with one or more features, one or more generations of a wireless network, one or more modes of operation, or any combination thereof, where the indication of the update includes an indication of a time at which the update is to occur relative to a reference point and means for communicating with a second wireless device in accordance with the update to the one or more parameters after the time at which the update is to occur.

Another innovative aspect of the subject matter described in this disclosure can be implemented in a non-transitory computer-readable medium storing code for wireless communications is described. The code may include instructions executable by one or more processors to transmit an indication of an update to one or more parameters, at least a threshold duration prior to the update, associated with one or more features, one or more generations of a wireless network, one or more modes of operation, or any combination thereof, where the indication of the update includes an indication of a time at which the update is to occur relative to a reference point and communicate with a second wireless device in accordance with the update to the one or more parameters after the time at which the update is to occur.

In some examples of the method, the first wireless devices, and the non-transitory computer-readable medium described herein, a difference between the time at which the update may be to occur and the reference point may be greater than or equal to the threshold duration and the reference point may be a time at which the indication of the update may be received or may be an absolute time reference, or both.

In some examples of the method, the first wireless devices, and the non-transitory computer-readable medium described herein, the indication of the update may be transmitted to one or more additional wireless devices, from a set of multiple additional wireless devices, that may be capable of supporting at least a first generation of the one or more generations of the wireless network, may be capable of supporting at least one of the one or more features for which the update may be applicable, may have enabled at least one of the one or more features for which the update may be applicable, support one or more communication links for which the update may be applicable, or any combination thereof.

In some examples of the method, the first wireless devices, and the non-transitory computer-readable medium described herein, transmission of the indication of the update may be in accordance with the update being from a set of multiple updates defined as critical updates, in accordance with the update being associated with at least a first generation of the one or more generations of the wireless network, in accordance with the update being from a subset of the set of multiple updates, in accordance with the update affecting a first set of multiple additional wireless devices associated with a multiple BSS identifier (MBSSID) set, in accordance with the update affecting a second set of multiple additional wireless devices associated with a cohosted set, in accordance with the update being from one or more updates indicated by the second wireless device, or any combination thereof.

In some examples of the method, the first wireless devices, and the non-transitory computer-readable medium described herein, the indication of the update may be transmitted via one or more bits in a capability information field in a beacon frame, in a probe response frame, or both.

In some examples of the method, the first wireless devices, and the non-transitory computer-readable medium described herein, the indication of the update may be transmitted via an additional frame different than a beacon frame and different than a probe response frame and the additional frame may be transmitted a fixed duration offset from the beacon frame, the probe response frame, or both.

Another innovative aspect of the subject matter described in this disclosure can be implemented in a first wireless device for wireless communications is described. The first wireless device may include a processing system that includes processor circuitry and memory circuitry that stores code. The processing system may be configured to cause the first wireless device to receive an indication of an update to one or more parameters, at least a threshold duration prior to the update, associated with one or more features, one or more generations of a wireless network, one or more modes of operation, or any combination thereof, where the indication of the update includes an indication of a time at which the update is to occur relative to a reference point and communicate with a second wireless device in accordance with the update to the one or more parameters after the time at which the update is to occur.

Another innovative aspect of the subject matter described in this disclosure can be implemented in a method for wireless communications by a first wireless device is described. The method may include receiving an indication of an update to one or more parameters, at least a threshold duration prior to the update, associated with one or more features, one or more generations of a wireless network, one or more modes of operation, or any combination thereof, where the indication of the update includes an indication of a time at which the update is to occur relative to a reference point and communicating with a second wireless device in accordance with the update to the one or more parameters after the time at which the update is to occur.

Another innovative aspect of the subject matter described in this disclosure can be implemented in another first wireless device for wireless communications is described. The first wireless device may include means for receiving an indication of an update to one or more parameters, at least a threshold duration prior to the update, associated with one or more features, one or more generations of a wireless network, one or more modes of operation, or any combination thereof, where the indication of the update includes an indication of a time at which the update is to occur relative to a reference point and means for communicating with a second wireless device in accordance with the update to the one or more parameters after the time at which the update is to occur.

Another innovative aspect of the subject matter described in this disclosure can be implemented in a non-transitory computer-readable medium storing code for wireless communications is described. The code may include instructions executable by one or more processors to receive an indication of an update to one or more parameters, at least a threshold duration prior to the update, associated with one or more features, one or more generations of a wireless network, one or more modes of operation, or any combination thereof, where the indication of the update includes an indication of a time at which the update is to occur relative to a reference point and communicate with a second wireless device in accordance with the update to the one or more parameters after the time at which the update is to occur.

In some examples of the method, the first wireless devices, and the non-transitory computer-readable medium described herein, a difference between the time at which the update may be to occur and the reference point may be greater than or equal to the threshold duration and the reference point may be a time at which the indication of the update may be received or may be an absolute time reference, or both.

In some examples of the method, the first wireless devices, and the non-transitory computer-readable medium described herein, reception of the indication of the update by the first wireless device may be in accordance with the first wireless device being capable of supporting at least a first generation of the one or more generations of the wireless network, may be capable of supporting at least one of the one or more features for which the update may be applicable, may have enabled at least one of the one or more features for which the update may be applicable, support one or more communication links for which the update may be applicable, or any combination thereof.

In some examples of the method, the first wireless devices, and the non-transitory computer-readable medium described herein, reception of the indication of the update may be in accordance with the update being from a set of multiple updates defined as critical updates, in accordance with the update being associated with at least a first generation of the one or more generations of the wireless network, in accordance with the update being from a subset of the set of multiple updates, in accordance with the update affecting a first set of multiple additional wireless devices associated with a MBSSID set, in accordance with the update affecting a second set of multiple additional wireless devices associated with a cohosted set, in accordance with the update being from one or more updates indicated by the first wireless device, or any combination thereof.

In some examples of the method, the first wireless devices, and the non-transitory computer-readable medium described herein, the indication of the update may be transmitted via one or more bits in a capability information field in a beacon frame, in a probe response frame, or both.

In some examples of the method, the first wireless devices, and the non-transitory computer-readable medium described herein, the indication of the update may be transmitted via an additional frame different than a beacon frame and different than a probe response frame and the additional frame may be received a fixed duration offset from the beacon frame, the probe response frame, or both.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example of a wireless communication network.

FIG. 2 shows an example of a signaling diagram that supports advanced notification of critical updates.

FIGS. 3A, 3B and 3C show examples of information element formats that support advanced notification of critical updates.

FIG. 4 shows an example of a process flow that supports advanced notification of critical updates.

FIG. 5 shows a block diagram of an example wireless communication device that supports advanced notification of critical updates.

FIG. 6 shows a block diagram of an example wireless communication device that supports advanced notification of critical updates.

FIGS. 7 and 8 show flowcharts illustrating example processes performable by or at a first wireless device that supports advanced notification of critical updates.

Like reference numbers and designations in the various drawings indicate like elements.

### DETAILED DESCRIPTION

The following description is directed to some particular implementations for the purposes of describing innovative aspects of this disclosure. However, a person having ordinary skill in the art will readily recognize that the teachings herein can be applied in a multitude of different ways. Some or all of the described implementations may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described implementations can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described implementations also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless devices, such as access points (APs), may support a capability to indicate critical updates (such as updates to one or more parameters associated with a basic service set (BSS)) to other wireless devices, such as wireless stations (STAs), at or after the critical updates occur. For example, an AP may transmit, to a STA (such as a non-AP STA) a Traffic Indication Map (TIM) broadcast frame including a Check Beacon field. If a value of the Check Beason field indicated in the TIM broadcast frame is different from a value stored by the STA, the STA may monitor a next beacon frame to identify and retrieve information about a critical update that has already occurred. In some other implementations, the AP may transmit an indication of a critical update via a Critical Update Flag (CUF) bit of a beacon. In such implementations, if a value of the CUF bit is set to 1, the STA may decode a BSS Parameters Change Count (BPCC) field in a Reduced Neighbor Report (RNR) element of the beacon and compare one or more values of the BPCC field against one or more stored values to identify the critical update and the link on which the critical update has occurred. However, indicating a critical update after the critical update has occurred may increase latency and communication interruptions as the STA decodes and responds to the update.

Various aspects relate generally to a first wireless device (such as an AP) indicating a critical update and a time at which the critical update is expected to occur to a second wireless device (such as a non-AP STA) at least a threshold duration prior to the critical update occurring. The critical update may include an update to one or more parameters associated with one or more communication features, associated with one or more generations of a wireless network, associated with one or more modes of operation, or any combination thereof. For example, the one or more communication features may be associated with a non-primary channel access (NPCA), a dynamic bandwidth expansion, dynamic sub-band operation (DSO), dynamic power saving (DPS), long-term power saving, in-device co-existence operation, dynamic unavailability operation (DUO), coordinated TDMA (Co-TDMA), coordinate beamforming (Co-BF), coordinated Spatial Re-use (CO-SR), coordinated restricted Target Wake Time (Co-rTWT), or any combination thereof. Additionally, or alternatively, the one or more generations may include a first generation associated with ultra-high reliability (UHR) communications, a second generation associated with extremely high throughput (EHT) communications, a third generation beyond the first generation and the second generation, or any combination thereof. Additionally, or alternatively, the one or more modes of operation may include a DSO mode, a DPS mode, a long-term power saving mode, a DUO mode, a Co-TDMA mode, a Co-BF mode, a Co-SR mode, a Co-rTWT mode, or any combination thereof.

In some implementations, the AP may indicate the time at which the critical update is expected to occur via a difference between a time at which the indication of the critical update is received and the time at which the critical update is expected to occur, via a quantity of time units, via a quantity of beacon intervals, via an absolute time reference, or any combination thereof. Additionally, or alternatively, the indication of the critical update may include an indication of one or more communication links for which the critical update applies, additional information about the critical update, or both.

In some implementations, the AP may communicate with multiple STAs and transmit the indication of the critical update to a subset (such as one or more) of the multiple STAs. In such implementations, the subset of the multiple STAs may include one or more STAs that support the one or more generations of the wireless network (such as is an ultra-high reliability (UHR) STA), one or more STAs that are capable of supporting one or more features for which the critical update applies, one or more STAs that have enabled the one or more features for which the critical update applies, one or more STAs that support the one or more communication links for which the critical update applies, or any combination thereof.

Particular aspects of the subject matter described in this disclosure can be implemented to realize one or more of the following potential advantages. By communicating the indication of the critical update prior to the critical updating occurring, the STA may respond to the critical update (such as by performing one or more actions) prior to the critical update occurring, which may reduce latency and may reduce communication interruptions. That is, reduction of communication interruptions may improve a threshold performance (such as worst-case performance) associated with the STA and the AP, thereby improving reliability of transmissions. Additionally, or alternatively, by transmitting the indication of the critical update to the subset of the multiple STAs, other STAs to which the critical update may not apply may save power by ignoring (such as not receiving, decoding, or both) the indication of the critical update. Additionally, or alternatively, by transmitting the indication of the critical update in accordance with the techniques described herein, one or more STAs (such as legacy STAs) that may not support receiving an indication of a critical update prior to the critical updating occurring, may not support one or more features associated with the critical update, may not support one or more generations of the wireless network for which the critical update applies, or any combination thereof, may not be affected by the indication of the critical update. That is, the one or more STAs may not attempt to decode the indication of the critical update, may not attempt to apply the critical update, or both, based on transmission of the indication of the critical update in accordance with the techniques described herein.

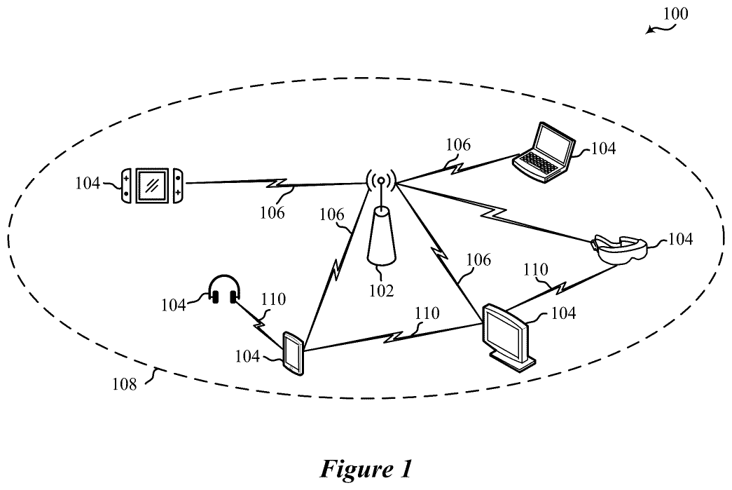

FIG. 1 shows a pictorial diagram of an example wireless communication network 100. According to some aspects, the wireless communication network 100 can be an implementation of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other implementations, the wireless communication network 100 can be an implementation of a cellular radio access network (RAN), such as a 5G or 6G RAN that implements one or more cellular protocols such as those specified in one or more 3GPP standards. In some other implementations, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other implementations, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other implementations. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other implementations.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHZ, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions.

Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One implementation of such a network is an ad hoc network (or wireless ad hoc network). Ad hoc networks may alternatively be referred to as mesh networks or P2P networks. In some implementations, ad hoc networks may be implemented within a larger network such as the wireless communication network 100. In such implementations, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Implementations of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHz, and 60 GHz bands. Some implementations of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHZ), FR3 (7.125 GHz-24.25 GHz), FR4a or FR4-1 (52.6 GHZ 71 GHZ), FR 4 (52.6 GHz-114.25 GHZ), and FR 5 (114.25 GHz-300 GHZ).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some implementations, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some implementations, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some implementations, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some implementations, the control frame and fields within the MAC header of the data or management frames, or both, also may be secured either via encryption or via an integrity check (such as by generating a message integrity check (MIC) for one or more relevant fields.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some implementations may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some implementations of such TDMA techniques, each portion of a plurality of portions of the TXOP includes a set of time resources that do not overlap with any time resources of any other portion of the plurality of portions of the TXOP. In such implementations, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some implementations of OFDMA techniques, each portion of the plurality of portions of the TXOP includes a set of frequency resources that do not overlap with any frequency resources of any other portion of the plurality of portions. In such implementations, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some implementations in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some implementations, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific implementations, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, For example, a receive (RX) power or RSSI measured by the respective AP. In some other implementations, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

Some APs and STAs, such as, For example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some implementations, MLO supports establishing multiple different communication links (such as a first link on the 2.4 GHZ band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, For example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some implementations, the exchange of information may occur via a beacon frame, a probe request frame, a probe response frame, an association request frame, an association response frame, another management frame, a dedicated action frame, or an operating mode indicator (OMI), among other implementations. In some implementations, an AP MLD may designate a specific channel of one link in one of the bands as an anchor channel on which it transmits beacons and other control or management frames periodically. In such implementations, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some implementations be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some implementations, the parallel communication links may support synchronized transmissions. In some other implementations, or during some other durations of time, transmissions over the communication links may be parallel, but not be synchronized or concurrent. Additionally, in some implementations or durations of time, two or more of the communication links may be used for communications between MLDs in the same direction (such as all uplink or all downlink), while in some other implementations or durations of time, two or more of the communication links may be used for communications in different directions (such as one or more communication links may support uplink communications and one or more communication links may support downlink communications). In such implementations, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an implementation, a single STA MLD may access a web browser while streaming a video in parallel. Per the above implementation, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other implementations, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some implementations, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some implementations, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in implementations in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHZ band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In implementations in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product).

Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the implementation of a single BSS. For example, MLA may increase the number of users per multiplexed transmission served by the multi-link AP MLD.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, For example, increase throughput or capacity, reduce latency or otherwise enhance user experience.

In some implementations, the wireless communications network 100 may support advanced notification of critical updates. For example, an AP 102 may transmit an indication of a critical update (such as an update to one or more parameters associated with one or more features, associated with one or more generations of a wireless network, associated with one or more modes of operation, or any combination thereof) at least a threshold duration prior to a time at which the critical update is expected to occur. The indication of the critical update may include an indication of the time at which the critical update is expected to occur. In some implementations, the AP 102 may indicate the time at which the critical update is to occur as a difference between a time at which the indication of the critical update is received and the time at which the critical update is to occur, via a quantity of time units, via a quantity of beacon intervals, via an absolute time reference, or any combination thereof.

Additionally, or alternatively, the indication of the critical update may include an indication of one or more communication links for which the critical update applies, additional information about the critical update, or both.

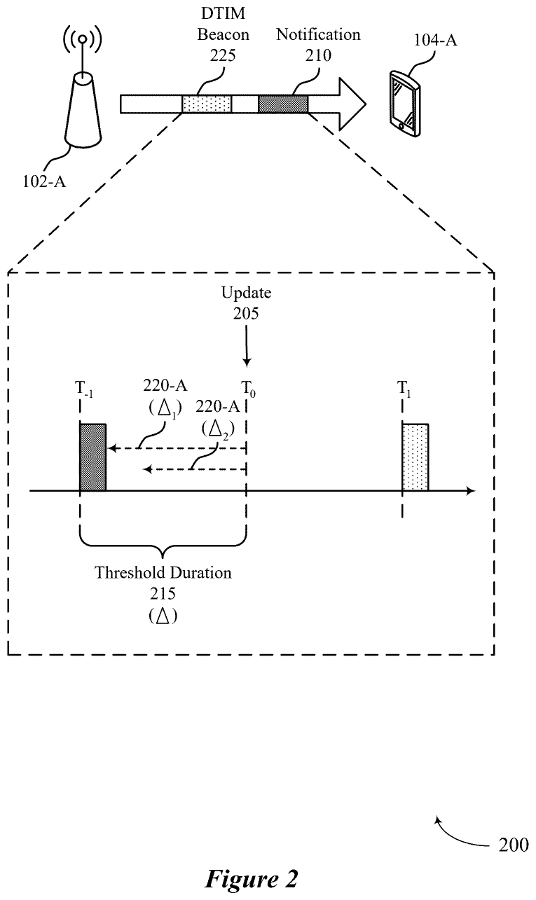

FIG. 2 shows an example of a signaling diagram 200 that supports advanced notification of critical updates. In some implementations, the signaling diagram 200 may implement or be implemented by aspects of the implementation wireless communication network 100. For example, the signaling diagram 200 may implement or be implemented by one or more STAs 104 (such as a STA 104-a), one or more APs 102 (a AP 102-a), or both, as described with reference to FIG. 1.

Though described and depicted in the context of the AP 102-a and the STA 104-a, this is not to be regarded as a limitation of the present disclosure. In this regard, the AP 102-a is merely an implementation of a first wireless device and the STA 104-a is merely an implementation of a second wireless device, such that other types of wireless devices, other combinations of wireless devices, or both, may be considered with regard to the techniques described herein. For example, the STA 104-a may be interchangeable with another AP 102 that is coordinating with the AP 102-a. That is, a first AP 102 and a second AP 102 may belong to an overlapping BSS (OBSS) such that the first AP 102 and the second AP 102 may coordinate with each other in accordance with one or more coordinated AP (CAP) schemes (such as in accordance with a Co-rTWT, Co-TDMA, Co-BF, Co-SR, or any combination thereof).

In some wireless communications systems (such as networks), some wireless devices, such as APs 102, may support a capability to indicate critical updates to other wireless devices, such as STAs 104 (such as non-AP STAs, client devices, APs, such as coordinating APs, or any combination thereof), after the critical updates have occurred. A critical update may be defined (such as classified) as an update to one or more parameters (such as associated with a BSS) associated with an AP 102 that may result in communication interruptions if a STA 104 is not capable of responding to the critical update prior to initiating transmissions with the AP 102 via one or more affected communication links (such as one or more communication links for which the critical update is applied). For example, if a STA 104 is not aware of an update to one or more Enhanced Distributed Channel Access (EDCA) parameters associated with an AP 102 prior to the update occurring, the STA 104 may attempt to communicate with the AP 102 in accordance with one or more outdated values (such as values prior to the update) of the one or more EDCA parameters after the update has occurred, which may result in delayed, failed or unfair communications between the STA 104 and the AP 102.

In some implementations, an AP 102 may support one or more mechanisms for indicating to one or more STAs 104 that a critical update has occurred (such as to notify the STAs 104 of the critical update). For example, the one or more STAs 104 (such as pre-extremely high throughput (EHT) STAs 104, STAs 104 that do not support EHT) may monitor for and the AP 102 may transmit a Traffic Indication Map (TIM) broadcast frame (such as short, periodic frame) that includes a Check Beacon field. If a value of the Check Beacon field indicated in the TIM broadcast frame is different from a value stored by a STA 104 (such as of the one or more STAs 104), the STA 104 may monitor (such as check) a next beacon frame to identify and retrieve information about a critical update that has already occurred. In some other implementations (such as for EHT STAs 104 and beyond, STAs 104 that support at least EHT), the AP 102 may transmit an indication of the critical update via a Critical Update Flag (CUF) bit of a beacon (such as a beacon frame) via a communication link associated with the update or a partner communication link (such as a link on which another AP of the AP MLD operates). In such implementations, if a value of the CUF bit is set to 1, the STA 104 may parse a remainder of the beacon and identify one or more communication links on which the critical update has occurred, which may be referred to as affected communication links, by decoding the corresponding BSS Parameters Change Count (BPCC) fields in a Reduced Neighbor Report (RNR) element of the beacon. The STA 104 may compare one or more values indicated via the BPCC fields against one or more values stored by the STA 104 to identify the one or more affected communication link. Thus, the STA 104 may receive one or more additional beacons on the one or more affected communication links, probe the one or more affected communication links, transmit a multi-link (ML) probe request via the one or more affected communication links, or any combination thereof to retrieve the one or more critical updates.

The one or more mechanisms associated with indicating that a critical update has occurred may enable the one or more STAs 104 to wake up and parse a beacon when the critical update has occurred and skip parsing the beacon otherwise (such as when no critical update has occurred), thus enabling the one or more STAs 104 to save power. However, the one or more mechanisms provide an indication of the critical update after the critical update has occurred, which may result in communication inefficiencies. That is, in some implementations, a STA 104 (such as of the one or more STAs 104) may perform one or more actions in response to the critical update but may not be able to initiate the one or more actions until the indication of the critical update is received after the critical update has occurred, which may result in in communication interruptions and increased latency. For example, the AP 102 may update a static puncturing pattern associated with a BSS of the AP 102 and, in such implementations, after the updated static puncturing pattern takes effect (such as the update to the static puncturing pattern occurs) the STA 104 may not occupy one or more punctured channels associated with the updated static puncturing pattern. However, the STA 104 may take a finite (such as non-negligible) amount of time (such as duration) to process and respond (such as react) to the update. Thus, when the STA 104 receives an indication of the update to the static puncturing pattern after the update has occurred, the STA 104 may refrain from communicating with the AP 102 during the finite amount of time while the STA 104 responds to the update, resulting in communication interruptions and increased latency.

Accordingly, techniques described herein may enable a first wireless device, such as the AP 102-a (such as an ultra-high reliability (UHR) AP 102), to announce an update 205 (such as a critical update or an upcoming update) to a second wireless device, such as a STA 104-a (such as a STA1), before the update 205 occurs. That is, if an update 205 is about to occur, the AP 102-a may transmit (such as output) a notification 210 (such as an announcement or an indication) of the update 205 at a time T₋₁ before a time To at which the update 205 is to occur (such as before the update 205 occurs). Specifically, the AP 102-a may transmit the notification 210 at least a threshold duration 215 (such as A) prior to the update 205 occurring.

In some implementations, the threshold duration 215 (such as a value of the threshold duration 215) may be long enough (such as may exceed a second threshold duration 215) such that at least a threshold quantity of STAs 104 from a set of STAs 104 communicating with the AP 102-a, including at least the STA 104-a, may wake up at least once to receive the notification 210 (such as via a beacon). Additionally, or alternatively, the threshold duration 215 may be greater than or equal to largest listen interval (such as a threshold listen interval) from among the set of STAs 104 associated with the AP 102-a. For example, the STA 104-a may be associated with a first listen interval and another STA 104 from the set of STAs 104 may be associated with a second listen interval, shorter than the first listen interval, such that the threshold duration 215 may be greater than or equal to the first listen interval.

Additionally, or alternatively, the threshold duration 215 may be based on multiple requested durations 220 (such as multiple desired values of the threshold duration 215) associated with the set of STAs 104. In other words, a requested duration 220 may be a threshold duration (such as minimum duration) associated with a STA 104 responding to the update 225. Thus, each STA 104 from the set of STAs 104, associated with the AP 102-a, may transmit an indication of a respective requested duration 220 and the AP 102-a may select the threshold duration 215 such that the threshold duration 215 is greater than or equal to the requested durations 220 indicated by the set of STAs 104. For example, the STA 104-a may transmit, to the AP 102-a at a first time, a first association request frame (or reassociation request frame or a link reconfiguration frame) indicating a first value of a requested duration 220-a (such as Δ₁) and another STA 104 (such as a STA2) from the set of STAs 104 may transmit, to the AP 102-a, a second associated request frame indicating a first value of a requested duration 220-b (such as Δ₂). The STA 104-a may transmit, at a second time later than the first time, a second value of the requested duration 220-a (such as Δ₃) that is different from the first value of the requested duration 220-a (such that Δ₃≠Δ₁). Thus, the AP 102-a may select the threshold duration 215 such that the threshold duration 215 is greater than or equal to both a latest value of the requested duration 220-a (such as the second value of the requested duration 220-a) and the first value of the requested duration 220-b. For example, if the second value of the requested duration 220-a is different than the first value of the requested duration 220-b, the AP 102-a may select the threshold duration 215 to be a greater (such as higher or longer) value of a requested duration 220 from the second value of the requested duration 220-a and the first value of the requested duration 220-b.

In some implementations, the AP 102-a may transmit the notification 210 to all of the STAs 104 from the set of STAs 104 associated with the AP 102-a. In some other implementations, the AP 102-a may transmit the notification 210 to one or more STAs from the set of STAs 104 (such as a subset of the set of STAs 104), which may be referred to as relevant STAs 104. A relevant STA 104 may be a STA 104 that supports one or more generations of a wireless network (such as UHR and beyond), a STA 104 that is capable of supporting one or more features (such as mechanisms) to which the update 205 applies, a STA 104 that has enables the one or more features to which the update 205 applies, a STA 104 that supports (such as has set up) one or more communication links on which the update 205 will occur, or any combination thereof. In such examples, the one or more features may include, or be associated with, an NPCA, a dynamic bandwidth expansion, DSO, DPS, long-term power saving, in-device coexistence, DUO, Co-TDMA, Co-BF, Co-SR, Co-rTWT, or any combination thereof.

In some implementations, the AP 102-a may transmit notifications 210 for one or more updates from a set of updates 205 (such as a list of updates 205), where the set of updates 205 are associated with the AP 102-a enabling or disabling one or more modes, updating one or more parameters (such as Co-TDMA parameters, Co-BF parameters, Co-SR parameters, Co-rTWT parameters, or a buffer status) associated with the one or more modes, or both. For example, the set of updates 205 may include any combination of:
a first update 205 associated with the Ap 102-a disabling a non-primary channel access (NPCA) mode (such that the STA 104-a may no longer be able to transmit a frame to the AP 102-a on as NPCA primary channel based on the NPCA mode being disabled in accordance with the first update 205);
a second update 205 associated with the AP 102-a enabling the NPCA mode (such that the STA 104-a may begin to access the NPCA primary channel based on the NPCA mode being enabled in accordance with the second update 205, thereby improving the communication latency);
a third update 205 associated with the AP 102-a updating (such as changing) one or more NPCA operational parameters, such as an NPCA switching delay, an NPCA switch back delay, or both (such that the STA 104-a may account for the one or more updated, or new, operational parameters, such as NPCA switching delay, the updated NPCA switch back delay, or both, in response to the third update 205, when exchanging frames with the AP 102-a on the NPCA primary channel);
a fourth update 205 associated with the AP 102-a updating the NPCA primary channel (such that the STA 104-a may switch to the updated NPCA primary channel, in response to the fourth update 205, when the STA 104-a detects an OBSS activity);
a fifth update 205 associated with the AP 102-a updating (such as changing) an NPCA minimum duration threshold (such that the STA 104-a may switch to the NPCA primary channel based on the latest values announced by the AP 102-a in response to the fifth update 205, thereby improving the communication latency);
a sixth update 205 associated with the AP 102-a enabling the DSO mode (such that the STA 104-a may be scheduled on the DSO sub-band based on the DSO mode being enabled in accordance with the second update 205, thereby improving the communication latency);
a seventh update 205 associated with the AP 102-a updating a dynamic sub-band operation (DSO) sub-band within a BSS associated with the AP 102-a or for a given STA 104, such as the STA 104-a (such that the STA 104-a may be ready to switch to the updated DSO sub-band within a short interframe space (SIFS), in response to the seventh update 205, after receiving a DSO initial control frame (ICF));
an eighth update 205 associated with the AP 102-a updating (such as changing) one or more DSO operational parameters, such as one or more anchor channels associated with one or more DSO sub-bands (such that the STA 104-a may account for the one or more updated, or new operational parameters, such as the one or more anchor channels, in response to the eighth update 205, when exchanging frames with the AP 102-a on the one or more DSO sub-bands);
a ninth update 205 associated with the AP 102-a entering, or enabling, a dynamic power saving (DPS) mode or an in-device coexistence mode (such that the STA 104-a may precede uplink frames with an ICF in response to the ninth update 205);
a tenth update 205 associated with the AP 102-a updating (such as changing) one or more operational parameters associated with a DPS mode, an in-device coexistence mode, a DUO mode, or any combination thereof, such as a padding delay (such that the STA 104-a may account for the one or more updated, or new, operational parameters, such as the padding delay, in response to the tenth update 205, when exchanging frames with the AP 102-a);
an eleventh update 205 associated with the AP 102-a entering, or enabling, a long-term power save mode or updating (such as changing) one or more operational parameters associated with the long-term power save mode, such as a duration for which the AP 102-a will operate in the long-term power save mode (such that the STA 104-a may not transmit any frames to the AP 102-a in response to the eleventh update 205);
a twelfth update 205 associated with the AP 102-a entering, or enabling, a dynamic bandwidth extension mode or updating (such as changing) one or more operational parameters associated with the dynamic bandwidth expansion mode, such as a duration associated with the AP 102-a operating in the expanded bandwidth mode, a bandwidth to be used by the AP 102-a while operating in in the dynamic bandwidth operation mode, or both (such that the STA 104-a may receive one or more PPDUs that occupy the bandwidth in response to the twelfth update 205); and
a thirteenth update 205 associated with the AP 102-a leaving, or disabling, the dynamic bandwidth extension mode or updating (such as changing) one or more operational parameters associated with a regular bandwidth mode, such as a duration associated with the AP 102-a operating in the regular bandwidth mode, a bandwidth to be used by the AP 102-a while operating in the regular bandwidth operation mode, or both (such that the STA 104-a may no longer transmit one or more PPDUs that occupy an expanded bandwidth in response to the thirteenth update 205);
a fourteenth update 205 associated with the AP 102-a entering, or enabling, a mode associated with secure control frame transmissions or updating (such as changing) one or more operational parameters associated with the secure control frame transmissions, such as a duration associated with processing a secure control frame, a response to the secure control frame, or both (such that the STA 104-a may account for the one or more updated, or new, operational parameters, such as the duration associated with processing the secure control frame, the response to the secure control frame, or both, when exchanging frames with the AP 102-a);
a fifteenth update 205 associated with the AP 102-a leaving, or disabling, a mode associated with a secure control frame transmission (such that the STA 104-a may stop using secure control frames when exchanging frames with the AP 102-a).

In some implementations, the AP 102-a may transmit notifications 210 for all updates 205 from the set of updates 205 (such as all critical updates), for all updates 205 (such as from the set of updates 205) associated with the one or more generations of the wireless network (such as UHR and beyond), for all updates 205 (such as from the set of updates 205) associated with one or more features (such as for a subset of the set of updates 205), for updates 205 (from the set of updates 205) that affect multiple APs 102 associated with a multiple BSS identifier (MBSSID) set, for updates 205 (from the set of updates 205) that affect multiple APs 102 associated with a cohosted set, or any combination thereof. In some implementations, the set of STAs 104 may request to receive advanced notification of one or more updates 205, such that the subset of the set of updates 205 includes the one or more updates 205 requested by the set of STAs 104.

In some implementations, the notification 210 may include an explicit indication of the update 205. For example, a first portion (such as an early portion) of a beacon frame, a probe response frame, or both, may include the indication of the update 205, such that the STA 104-a may parse the first portion of the beacon frame, the probe response frame, or both, to determine if an update 205 is upcoming and, if not, skip parsing a remainder, or second portion, of the beacon frame, the probe response frame, or both. In some implementations, the first portion may include a reserved field (such as a subfield in a capability information field) that may include one or more bits (such as B2, B3, B14, and B15) indicating the update 205. For example, the indication of the update 205 may be a binary indication where a first bit of the one or more bits may be set to a value of “1” indicating to the STA 104-a that the update 205 is upcoming (such as is going to occur or is about to occur) on at least one communication link (such as of an AP MLD) or may be set to “0” indicating that no update 205 is upcoming.

Additionally, or alternatively, one or more additional bits (such as of the one or more bits) may indicate a link identifier associated with the communication link, may indicate that more than one communication link is associated with the update 205 (such as via a value of 15), or both.

In some other implementations, another field in the first portion of the beacon frame, the probe frame, or both, may include the explicit indication of the update 205. For example, one or more bits in a TIM element of the beacon frame, the probe response frame, or both may carry the indication of the update 205. In some implementations, the AP 102-a may provide the indication of the update 205 via a binary indication (such that only one bit of the TIM element is used), via multiple bits (such that 4 bits of the TIM element are used), via a bitmap, or any combination thereof. When provided via multiple bits, one or more of the multiple bits may indicate the link identifier associated with the communication link, may indicate that more than one communication link is associated with the update 205 (such as via a value of 15), or both. When provided via a bitmap, the bitmap may indicate one or more link identifiers on which the update 205 is to occur (such that each bit in a 16 bit bitmap indicates a link identifier on which the update 205 is to occur).

In either implementation (such as when the indication of the update 205 is binary, is provided via multiple bits, or is provided via a bitmap), the AP 102-a may reserve an Association Identifier (AID) or a range of AIDs for providing an implicit indication of the update 205 (such as providing the notification 210), such that when a reserved AID is indicated via the TIM element, the TIM element indicates than the update 205 is going to occur. Conversely, an absence of a reserved AID in the TIM element may indicate that no update 205 is going to occur. For example, AID 50, AIDs 50-53, or AIDs 50-65 may be dedicated to providing the notification 210, such that when the TIM element indicates the AID 50, an AID within AIDs 50-53, or an AID within AIDs 50-65, respectively, the TIM element indicates than the update 205 is going to occur. In these implementations AIDs and AIDs ranges are not intended to be a limitation of the present disclosure, such that an AID or range of AIDs may be considered with regards to the techniques described herein. In some implementations, the AP 102-a may transmit, during association, an indication of configuration information associated with the explicit indication of the update 205, such as configuration information associated with one or more bit positions in the other field, configuration information associated with the AID, configuration information associated with the range of AIDs, or any combination thereof.

Additionally, or alternatively, the AP 102-a may transmit the notification 210 in one or more additional frames transmitted by the AP 103-a, such as a Fast Initial Link Setup (FILS) discovery frame, a dedicated critical update notification frame, a Multi-Link Update Notification frame including a Reconfiguration Multi-Link element, or the like thereof. In such implementations, the AP 102-a may transmit the additional frame a fixed duration (such as a time) offset from (such as before or after) the beacon frame, the probe response frame, or both. Alternatively, a CUF flag (such as B6 of a capability information field) may include the notification 210. That is, rather than CUF=1 indicating that an update 205 has occurred (such as in the past), CUF=1 may indicate that an update 205 has occurred or is going to occur.

In some implementations, the AP 102-a may transmit multiple instances of the notification 210. That is, the AP 102-a may transit a first instance of the notification 210 at the time T₋₁ and may transmit one or more additional instances of the notification 210 after the time T₋₁. In some implementations, the AP 102-a may transmit the one or more additional instances of the notification 210 until the update 205 occurs. In some other implementations, the AP 102-a may transmit the one or more additional instances of the notification 210 until all applicable STAs 104 have received (such as retrieved) the notification 210, where an applicable STA 104 is a STA 104 for which the update 205 applies (such as is a relevant STA 104, as described herein).

In such implementations, the AP 102-a may be capable of determining when each of the applicable STAs 104 have received the notification 210. For example, if an applicable STA 104 probes the AP 102-a on a communication link, the AP 102-a may respond to the probe with the notification 210, such that the AP 102-a is aware that the applicable STA 104 has received the notification 210 based on the notification 210 being transmitted in response to the probe. Additionally, or alternatively, an applicable STA 104 may include, in one or more frames, an indication that the applicable STA 104 has received the notification 210. For example, the indication that the applicable STA 104 received the notification 210 may be via a field in a PHY header (such as via a universal signal (U-SIG) field), via a MAC header (such as via an A-Control field), via a payload (such as via a multi-STA block ACK (M-BA) frame), or any combination thereof. This indication may be transmitted by the applicable STA 104 on any of the one or more communication links established between the applicable STA 104 and the AP 102-a.

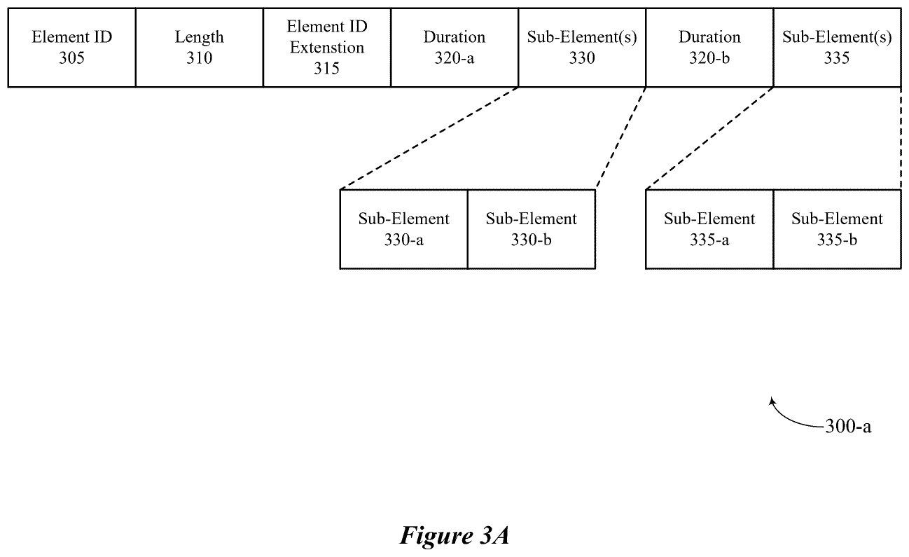

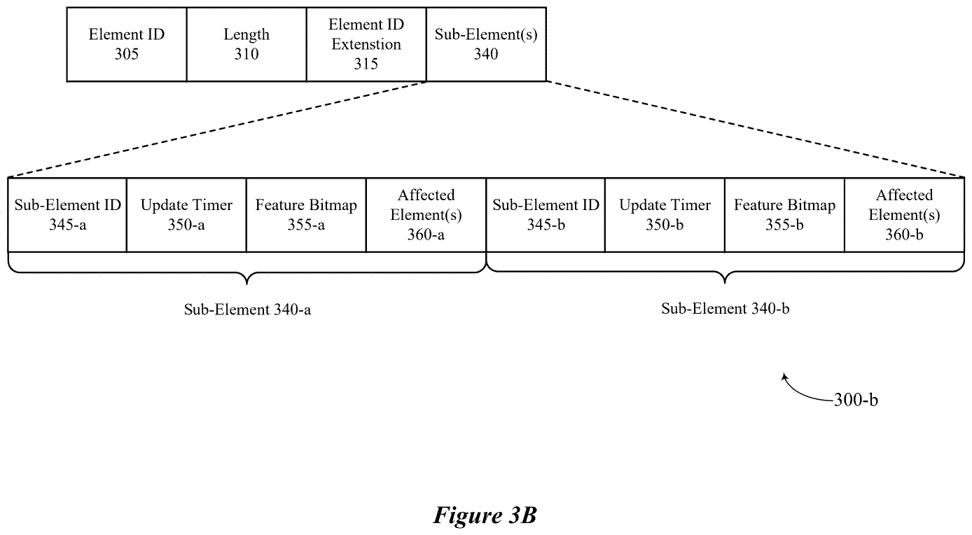

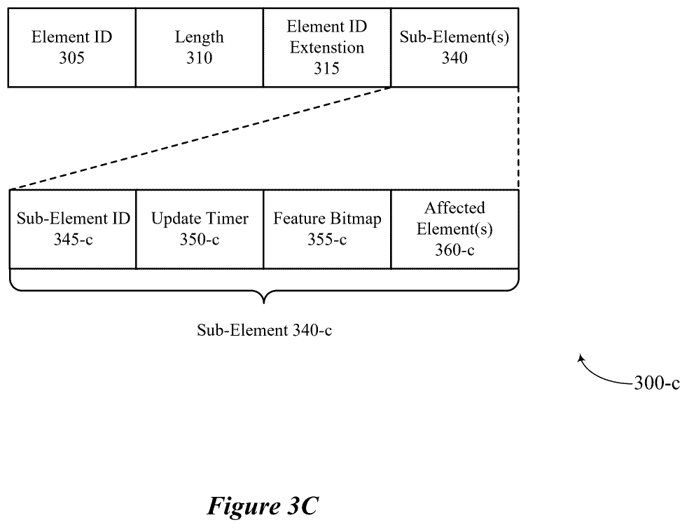

Thus, if the AP 102-a ascertains or otherwise determines that at least one applicable STA 104 has not received the notification 210, the AP 102-a may continue to transmit one or more additional instances of the notification 210, where the additional instances of the notification 210 may include additional information about the update, as described with reference to FIGS. 3A, 3B, and 3C, and may be included in all beacon frames, probe response frames, or both, transmitted by the AP 102-a. Additionally, or alternatively, the AP 102-a may transmit an additional instance of the notification 210 directly, via a unicast frame, to an applicable STA 104 that has not received the notification 210 and is in an active power state (such as on a same communication link as the update 205 or another communication link).

In some implementations, the notification 210 may additionally, or alternatively, include an indication of the time To at which the update 205 is to occur. The AP 102-a may indicate the time To via a difference (such as in microseconds, time units, or another unit of time that is announced by the AP 102-a) between the time To at which the update 205 is to occur and the time T₋₁ at which the notification 210 is received by the STA 104-a, via a countdown (such as in beacon intervals) to the time To at which the update 205 is to occur, via an absolute time reference (such as a time synchronization function (TSF) value) equivalent to the time To at which the update 205 is to occur, or any combination thereof. For example, the eight least significant bits (LSBs) of the TSF may be included in the notification 210. In some implementations, if the notification 210 is for multiple updates 25, the AP 102-a may include, in the notification 210, an indication of a respective time at which each update 205 of the multiple updates 205 is to occur, an earliest (such as minimum) time at which a first update 205 of the multiple updates 205 is to occur, or both. Indicating the earliest time at which the first, or earliest, update 205 is to occur may enable the STA 104-a to retrieve the notification 210 before the first update 205 occurs.

In some implementations, the notification 210 may indicate one or more communication links for which the update 205 applies (such as links on which the update has occurred or is expected to occur), which may be referred to as affected links. In some implementations, the indication of the one or more communication links may be coupled with the explicit indication of the update 205, as described herein, such that one or more STAs 104 that do not have the one or more affected communication links set up (such as with an AP MLD) may refrain from parsing a remainder of a beacon for additional information associated with the update 205, thereby saving power. In some other implementations, the indication of the one or more affected communication links may be separate from the explicit indication of the update 205. For example, when the explicit indication of the update 205 is a single bit update in a frame (such as a beacon frame or a probe response frame or a FILS discovery frame or a critical update notification frame or a multi-link update notification frame), the STA 104-a may parse a remainder of the frame to identify the one or more affected communication links. That is, the AP 102-a may signal the one or more affected communication links in a frame body, such as in a reduced neighbor report (RNR) element, where an entry corresponding to the affected AP 102-a in the RNR element may carry the indication that the update 205 is upcoming. In some implementations, the AP 102-a may signal the one or more affected communication links via a single bit indication (such as via an MLD parameter subfield) or via a counter-based indication (similar to a Check Beacon subfield, a BPCC subfield, or an 8-bit subfield in an extended MLD parameter subfield) such that the STA 104-a compares the value of the counter indicated by the AP 102 in a latest frame (such as a beacon frame or a probe response frame or a FILS discovery frame or a critical update notification frame or a multi-link update notification frame) with a local copy of the counter and infers, or otherwise determines, one or more affected communication links as those communication links for which the counter values do not match.

In some implementations, the AP 102-a may include an MLD identifier and one or more link identifiers in the notification 210 to indicate that the update 205 applies to one or more communication links of another AP MLD (such as an AP MLD that is located at a different physical location and is part of a single mobility domain entity). This may occur when the STA 104-a has performed link preparation (such as by adding one or more links of the other AP MLD, which may be a target AP MLD) and is about to roam to the other AP MLD. Including the MLD identifier and the one or more link identifiers in the notification 210 may enable the STA 104-a to be aware of the update 205 to the one or more communication links of the other AP MLD (such as the target AP MLD) before the STA 104-a roams to the other AP MLD, such that the STA 104-a may be aware of a newest set of parameters associated with the other AP MLD once the STA 104-a has transitioned to the other AP MLD, thereby reducing or eliminating and communication interruptions.

In some implementations, some updates 205 may be associated with a transition phase, where the AP 102-a, the STA 104-a, or both, may be restricted from, or may not be allowed to, transmit frames, receive frames, or both, on one or more affected communication links associated with the update 205 during the transition phase. In such implementations, the transition phase may include the time T₋₁ at which the notification 210 is received (or transmitted) to the time T₀ at which the update 205 occurs, the time T₀ at which the update 205 occurs to a time at which the update 205 is processed at the STA 104-a, or both. The time at which the update 205 is processed at the STA 104-a may be applicable when the AP 102-a is unable to provide the notification 210 early enough for the STA 104-a to process the update prior to the update 205 occurring. In such implementations, the STA 104-a may indicate, to the AP 102-a, the time at which the update 205 is processed at the STA 104-a. Additionally, or alternatively, the AP 102-a, the STA 104-a, or both, may indicate (such as to the other device) whether they are capable, or are allowed, to transmit frames, receive frames, or both, during the transition phase.

In some implementations, in addition transmitting the notification 210 of the update 205 at the time T₋₁ before the time To at which the update 205 occurs, the AP 102-a may additionally transmit a Delivery Traffic Indication Map (DTIM) beacon 225 at a time T₁ after the update 205 occurs to announce that the update 205 has occurred.

FIGS. 3A, 3B and 3C show examples of information element formats 300 that support advanced notification of critical updates. The examples of the information element formats 300 may include an information element format 300-a, an information element format 300-b, and an information element format 300-c. In some implementations, the information element formats 300 may implement or be implemented by aspects of the implementation wireless communication network 100, the signaling diagram 200, or both. For example, the information element formats 300 may be implemented by one or more STAs 104, one or more APs 102, or both, as described with reference to FIG. 1.

As described with reference to FIG. 2, an AP 102 may announce an update (such as via a notification 210) to a STA 104 before the update occurs. In some implementations, the AP 102 also may indicate additional information associated with the update, where an indication of the update that includes the additional information may be referred to as a detailed indication. In such implementations, the AP 102 may indicate the additional information via an update element in accordance with the information element format 300-a, the information element format 300-b, the information element format 300-c, or any combination thereof.

For example, the additional information may include an indication of one or more elements (or sub-elements) to be affected by the update, which may be referred to as affected elements. That is, the additional information may include an indication of one or more updated values of one or more parameters after the one or more parameters have been updated (such as via one or more first elements associated with the one or more parameters), an indication that one or more modes have been enabled (such as activated) or disabled (such as deactivated) by the update (such as via one or more second elements associated with the one or more modes), an indication that one or more features have been enable or disabled by the update (such as via one or more third elements associated with the one or more features), or any combination thereof. For example, if an update is associated with a change in an NPCA primary channel from a first NPCA primary channel associated with a first channel number to a second NPCA primary channel associated with a second channel number, the additional information may include an indication of the second channel number. In some implementations, the additional information may indicate the second channel number via a copy of an element in which an NPCA channel number is announced, such that a channel number reported via the element may be set to the second channel number (such as a new value). In some other implementations, the copy of the element may not include an entire copy of the element but only carry the values that are to be updated.

In some implementations, as described with reference to the information element format 300-a, the AP 102 may indicate the one or more affected elements, or sub-elements, more than once (such as twice) in a frame, such as a beacon frame or a probe response frame. That is, a first instance of an affected element in a frame may indicate one or more current values of the one or more parameters prior to the update, one or more current states of one or more modes (such as enabled or disabled) prior to the update, one or more current states of one or more features (such as enabled or disabled) prior to the update, or any combination thereof, and a second instance of the affected element in the frame may indicate one or more updated, or future, values of the one or more parameters after the update, one or more updated states of one or more modes (such as enabled or disabled) after the update, one or more updated states of one or more features (such as enabled or disabled) after the update, or any combination thereof.

In some implementations, the AP 102 may indicate the second instance of the one or more affected elements, or sub-elements, via an element (such as a critical update element) according to the information element format 300, as depicted in FIG. 3. That is, an element may include an element ID 305, a length 310, an element ID extension 315, a duration 320-a, one or more sub-elements 330, a duration 320-b, one or more sub-elements 335, or any combination thereof. In such implementations, the duration 320-a may be a first duration, or time, until a first update is to occur and the duration 320-b may be a second duration until a second update is to occur. Thus, the one or more sub-elements 330 may be associated with the first update and the one or more sub-elements 335 may be associated with the second update.

Further, the one or more sub-elements 330, including a sub-element 330-a and a sub-element 330-b, may indicate one or more updated values of one or more first parameters after the first update, one or more updated states of one or more first modes after the first update, one or more updated states of one or more first features after the first update, or any combination thereof. For example, the sub-element 330-a may be a UHR Operation sub-element indicating an updated state of the dynamic bandwidth expansion mode, and the sub-element 330-b may be an NPCA sub-element indicating one or more of an updated NPCA channel number, an updated NPCA switching delay, an updated NPCA switch back delay, an updated NPCA disabled subchannel bitmap, or an updated NPCA untriggered transmissions allowed.

Similarly, the one or more sub-elements 335, including a sub-element 335-a and a sub-element 335-b, may indicate one or more updated values of one or more parameters after the second update, one or more updated states of one or more modes after the second update, one or more updated states of one or more features after the second update, or any combination thereof. For example, the sub-element 330-a may be an EHT Operation sub-element indicating an updated value of one or more of the disabled subchannel bitmap, channel width, CCFS0, or CCFS1, and the sub-element 330-b may be a DPS sub-element indicating that a DPS mode is enabled or disabled for the AP or for the entire BSS. In some implementations, the element ID 305 may indicate that the element is associated with the information element format 300, or is a critical update element, such that one or more other STAs 104 that are not capable of receiving, or decoding, an indication of an update prior to the update occurring may skip a remainder of the element (such as skip receiving or decoding the duration 320-a, the one or more sub-elements 330, the duration 320-b, the one or more sub-elements 335, or any combination thereof).

Alternatively, the AP 102 may indicate the one or more affected elements once. That is, a frame may include a single instance of an affected element, where the single instance indicates one or more updated values of one or more parameters after the update, one or more updated states of one or more modes after the update, one or more updated states of one or more features after the update, or any combination thereof. For example, the AP 102 may indicate, to the STA 104 during association or reassociation, one or more current values of the one or more parameters, one or more current states of the one or more modes, one or more current states of the one or more features, or any combination thereof, such that the AP 102 may indicate a single instance of an affected element (such as via a notification 210 in a beacon frame) when an update is to occur to the one or more current values of the one or more parameters, the one or more current states of the one or more modes, the one or more current states of the one or more features, or any combination thereof. In such implementations, the STA 104 receiving the additional information indicating the single instance of the affected element may be a STA 104 associated with one or more generations of a wireless network (such as UHR and beyond) that support the indication of the one or more affected elements via a single instance.

Additionally, or alternatively, the AP 102 may indicate the one or more affected elements via an update element (such as a critical update element) associated with the information element format 300-b. Similar to the information element format 300-a, the information element format 300-b may include an element ID 305, a length 310, and an element ID extension 315. Additionally, or alternatively, the information element format 300-b may include one or more sub-elements 340, where each sub-element 340 includes a sub-element ID 345, an update timer 350, a feature bitmap 355, and one or more affected elements 360. The update timer may indicate a time (such as in time units or beacon intervals) after which the one or more affected elements 350 take effect. That is, the update timer 350 may indicate a time at which the update, indicated via the one or more affected elements 360, is to occur. The feature bitmap 355 may indicate a set of one or more features, as described with reference to FIG. 2, for which the update may apply, where a size of the feature bitmap 355 may be known to a STA 104 receiving the update element, such that the STA 104 may be capable of skipping parsing of the feature bitmap 355 if the STA 104 is not capable of decoding one or more bits of the feature bitmap 355. The feature bitmap 355 indicating the set of one or more features for which the update may apply may enable the STA 104 to efficiently parse the feature bitmap 355 (such as when the STA 104 is capable of decoding the feature bitmap 355) and may remove ambiguity if the STA 104 missed a previous update. Additionally, or alternatively, the one or more affected elements 360 may indicate one or more updated values of a subfield, field, sub-element, or any combination thereof, after the update takes effect. That is, the one or more affected elements 360 may indicate one or more updated values of one or more parameters after the the update, one or more updated states of one or more modes after the update, one or more updated states of one or more features after the update, or any combination thereof. Similar to the feature bitmap 355, a STA 104 may be aware of a size of the one or more affected elements 360, such that the STA 104 may be capable of skipping parsing of the one or more affected elements 360 if the STA 104 is not capable of decoding one or more affected elements 360 or a portion of the one or more affected elements 360.

In some examples, as depicted in FIG. 3B, the one or more sub-elements 340 may include multiple sub-elements 340. That is, the one or more sub-elements 340 may include a sub-element 345-a and a sub-element 345-b, where the sub-element 345-a includes a sub-element ID 345-a, an update timer 350-a, a feature bitmap 355-a, and one or more affected elements 360-a, and the sub-element 345-b includes a sub-element ID 345-b, an update timer 350-b, a feature bitmap 355-b, and one or more affected elements 360-b. In such examples, the AP 102 may include the sub-element 345-b in the update element based on a different update occurring at a different time.

That is, the sub-element 345-a may be associated with a first update that is to occur at a first time (such as T1), indicated via the update timer 350-a, and the sub-element 345-b may be associated with a second update that is to occur at a second time (such as T2), indicated via the update timer 350-b, where the first time is different than the second time and the first update is different than the second update. Otherwise, if the first time is the same as the second time, the first update is the same as the second update, or both, update element may not include the sub-element 340-b, as described with reference to FIG. 3C. Additionally, or alternatively, the sub-element 345-b may not be present in the update element if the AP 102 selects a value of the update timer 350-a based on a threshold time. That is, even if the first time is different than the second time, the AP 102 may select the shorter time of the first time and the second time, may indicate the shorter time via the update timer 350-a, and may indicate both the first update and the second update via the one or more affected elements 360-a.

For example, for two updates, such as a first update enabling an NPCA mode and a second update disabling a dynamic bandwidth expansion mode, the AP 102 may transmit the update element (such as in accordance with the information element format 300-b) including the sub-element 345-a associated with enabling the NPCA mode and the sub-element 345-b associated with disabling the dynamic bandwidth expansion mode. In such examples, the feature bitmap 355-a may indicate that a bit corresponding to the NPCA mode is set to 1 (such as indicating an update to the NPCA mode), while all other bits in the feature bitmap 355-a are set to 0, and the one or more affected elements 360-a may include a UHR operation element with an “NPCA Enabled” bit set to 1. Additionally, or alternatively, an “NPCA Operations Information” field in the UHR Operation element or an NPCA Operation element may indicate a value of an NPCA switching delay, a NPCA switch back delay, an NPCA primacy channel number, or any combination thereof, which are to take affect based on the first update (such as after the NPCA mode is enabled). Similarly, the feature bitmap 355-b may indicate that a bit corresponding to the dynamic bandwidth expansion mode is set to 1 (such as indicating an update to the dynamic bandwidth expansion mode), while all other bits in the feature bitmap 355-b are set to 0, and the one or more affected elements 360-b may include a UHR operation element with an “Dynamic Bandwidth Enabled” bit set to 0.

In some other implementations, such as depicted in FIG. 3C, the one or more sub-elements 340 may include a single sub-element 340. That is, the information element 300-b may be the same as the information element 300-c, except the information element 300-c may indicate a single sub-element 340-c, rather than multiple sub-elements 340, such as the sub-element 340-a and the sub-element 340-b. In some examples, the sub-element 340-c may indicate a single update, such as a third update disabling the NPCA mode. For example, the sub-element 340-c may include a sub-element ID 345-c, an update timer 350-c, a feature bitmap 355-c, and one or more affected elements 360-c. In such examples, the update timer 350-c may indicate 5 beacon intervals, which further indicates that the AP 102 may disable the NPCA mode after 5 beacon intervals. Additionally, the bit corresponding to the NPCA mode may be set to 1 (such as indicating an update to the NPCA mode), while all other bits in the feature bitmap 355-c may be set to 0, and the one or more affected elements 360-c may include the UHR operation element with the “NPCA Enabled” bit set to 0.

In another example, the sub-element 340-c may indicate multiple updates, such as the first update enabling the NPCA mode and the second update disabling the dynamic bandwidth mode. In such examples, the feature bitmap 355-c may indicate that the bit corresponding to the NPCA mode is set to 1 and the bit corresponding to the dynamic bandwidth expansion mode is set to 1, while all other bits in the feature bitmap 355-a may be set to 0. Additionally, or alternatively, the one or more affected elements 360-a may include the UHR operation element with the “NPCA Enabled” bit set to 1 and with the “Dynamic Bandwidth Enabled” bit set to 0. Further, the “NPCA Operations Information” field in the UHR Operation element or the NPCA Operation element may indicate the value of the NPCA switching delay, the NPCA switch back delay, the NPCA primacy channel number, or any combination thereof, which are to take affect based on the first update (such as after the NPCA mode is enabled). In such examples, the update timer 350-c, which may be referred to as a common update timer 350, may apply to both the first update and the second update. For example, the update timer 350-c may indicate 2 beacon intervals such that the AP 103 may enable the NPCA mode and disable the dynamic bandwidth expansion mode after 2 beacon intervals.

In some implementations, the AP 102 may provide the additional information on one or more affected communication links. That is, the AP 102 may communicate with one or more STAs 104 via multiple communication links and, when an update is to occur, may transmit an indication of the update (such as via a notification 210) via each of the multiple communication links. However, the update may apply to one or more communication links of the multiple communication links and not one or more communication links), thus, despite transmitting the indication of the update via each of the multiple communication links, the AP 102 may additionally transmit an indication of the additional information via the one or more affected communication links (and not via the one or more other communication links to which the update does not apply). In some other implementations, the AP 102 may transmit an indication of the additional information via all of the one or more communication links, including a communication link that is not an affected communication link. In such implementations, the AP 102 may include the indication of the additional information in a per-station profile sub-element of a basic multi-link element that is associated with the affected communication link.

Additionally, or alternatively, the AP 102 may be aware that a STA 104 may not be capable of decoding a beacon frame if a size of the beacon frame exceeds a threshold length. Thus, the AP 102 may include the additional information in a subset of beacon frames transmitted by the AP 102 (on a communication link that is an affected communication link, on a communication link that is not an affected communication link, or both). For example, the AP 102 may include the additional information in every third beacon frame transmitted by the AP 102. In such implementations, the AP 102 may indicate a periodicity associated with transmission of the additional information to one or more STAs 104 capable of receiving the additional information, such as during association or via a beacon frame. Thus, the STA 104 that is not capable of decoding the beacon frame if the size of the beacon frame exceeds the threshold length may be able to receive and decode the one or more beacon frames that do not include the additional information and whose size does not exceed the threshold length.

In some implementations, one or more updates from the set of updates, as described with reference to FIG. 2, may occur in parallel with (such as simultaneously or concurrently) another update that is applicable to a first type of STA 104 (such as EHT STAs 104, STAs 104 associated with an EHT generation of the wireless network). That is, a second type of STA 104 (such as a UHR STA 104) may support advanced notification of the one or more updates from the set of updates in accordance with the techniques described herein and the first type of STA (such as EHT STA 104) may support indication of the other update in accordance with one or more other notification mechanisms (such as one or more EHT critical update mechanisms). In such implementations, the AP 102 may provide an advance notification for the update from the set of updates 205 via the one or more other notification mechanisms associated with the other update, for the other update that is applicable to first type of STA 104 (such as a channel switch announcement mechanism), or both.

If the AP 102 provides separate notifications for the other update this is applicable to the first type of STA 103 and for the one or more updates from the set of updates 205, a time at which the one or more updates take effect (such as occurs) may be the same as a time at which the other updated takes effect. For example, the AP 102 may update an operating channel of the AP 102 at a future time and also may disable NPCA operations at the same time. The AP 102 may announce the update to the operating channel in accordance with a channel switch announcement mechanism or an extended channel switch announcement mechanism and provide an indication of the NPCA disablement via the advance notification mechanism described herein. However, a switch time field of a channel switch announcement element used to announce the update to the operating channel and an update timer 350 of an update element used to announce the NPCA disablement may indicate the same time in the future.

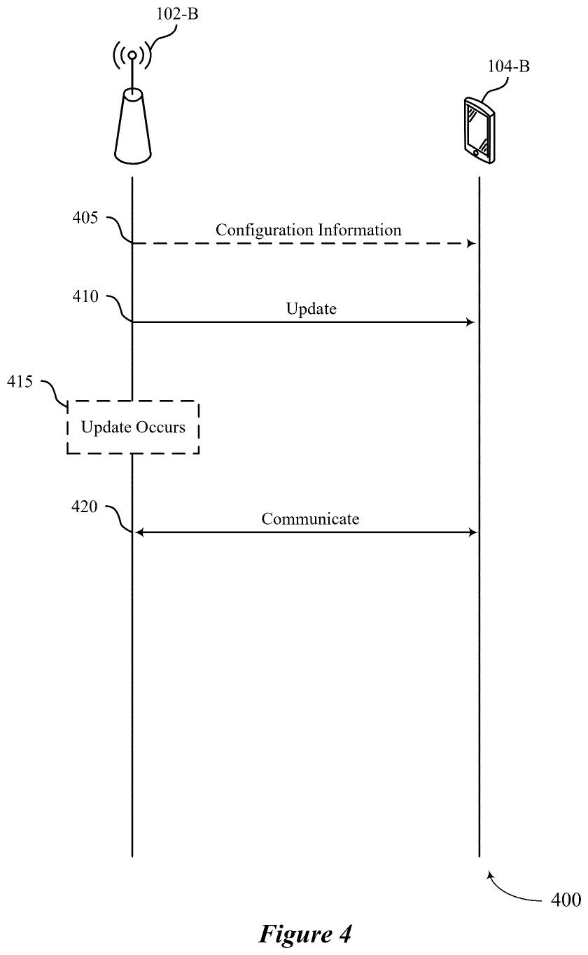

FIG. 4 shows an example of a process flow 400 that supports advanced notification of critical updates. In some implementations, the process flow 400 may implement or be implemented by aspects of the implementation wireless communication network 100, the signaling diagram 200, the information element formats 300, or any combination thereof. For example, the process flow 400 may implement or be implemented by one or more STAs 104 (such as a STA 104-b), one or more APs 102 (such as an AP 102-b), or both, as described with reference to FIG. 1. In the following description of the process flow 400, the operations between the STA 104-b and the AP 102-b may be communicated in a different order than the implementation order shown, or the operations performed by the STA 104-b and the AP 102-b may be performed in different orders or at different times. Some operations also may be omitted from the process flow 400, and other operations may be added to the process flow 400.

In some implementations, at 405, a first wireless device, such as the AP 102-b may transmit, to a second wireless device, such as the STA 104-a, configuration information associated with one or more bits used to indicate an update, a capability information field used to indicate the update, or both. Additionally, or alternatively, the configuration information may indicate one or more AIDs, from multiple AIDS, reserved for indicating upcoming updates.

At 410, the AP 102-b may transmit an indication of an update to one or more parameters associated with one or more features, one or more generations of a wireless network (such as UHR and beyond), one or more modes of operation, or any combination thereof. In such implementations, the AP 102-b may transmit the indication of the update at least a threshold duration prior to the update occurring, at 415. In some implementations, the threshold duration may be in accordance with a capability of each STA 104 of multiple STAs 104, including at least the STA 104-a, to wake up at least once prior to the time at which the update is to occur, in accordance with a threshold listen interval out of the multiple STAs 104, or any combination thereof. For example, the AP 102 may receive, from each STA 104 of multiple STAs 104, a respective indication a respective threshold duration of multiple threshold durations and the AP 102-b may select the threshold duration such that the threshold duration is a longest threshold duration out of the multiple threshold durations indicated by the multiple STAs 104.

In some implementations, the indication of the update may include an indication of a time at which the update is to occur relative to a reference point. In such implementations, a difference between the time at which the update is to occur and the reference point may be greater than or equal to the threshold duration. Additionally, or alternatively, the reference point may be a time at which the indication of the update is received or may be an absolute time reference. Additionally, or alternatively, the indication of the update may be from multiple indications of updates transmitted by the AP 102-b via a signal, such that, in some implementations, the update associated with the time relative to the reference point may be an earliest occurring update of the plurality of future updates or, in some other implementations, the signal may include an indication of a respective time at which each update of the multiple updates are to occur relative to the reference point.

In some implementations, the AP 102-a may be associated with (such as may communicate with) multiple STAs 104, including a least the STA 104-b, and the AP 102-a may transmit the indication of the update to a subset (such as one or more) of the STAs 104 from multiple STAs 104, including a least the STA 104-b. In such implementations, the AP 102-b may transmit the indication of the update to the subset of STAs 104 in accordance with the each STA 104 of the subset of STAs 104 being capable of supporting at least a first generation of the one or more generations of the wireless network, being capable of supporting at least one of the one or more features for which the update is applicable, having enabled at least one of the one or more features for which the update is applicable, supporting one or more communication links for which the update is applicable, or any combination thereof.

Additionally, or alternatively, transmission of the indication of the update may be in accordance with the update being from a set of updates defined as critical updates, in accordance with the update being associated with at least a first generation of the one or more generations of the wireless network, in accordance with the update being from a subset of set of updates, in accordance with the update affecting a first set of STAs 104 associated with an MBSSID set, in accordance with the update affecting a set of STAs 104 associated with a cohosted set, in accordance with the update being from one or more updates indicated by the STA 104-b, or any combination thereof. For example, the subset of the set of updates may include any combination of the first update 205, the second update 205, the third update 205, the fourth update 205, the fifth update 205, the sixth update 205, the seventh update 205, the eight update 205, the ninth update 205, and the tenth update 205, as described with reference to FIG. 2.

In some implementations, the AP 102-b may transmit the indication of the update via one or more bits in the capability information field in a beacon frame, a probe response frame, or both, in accordance with the configuration information. For example, a first bit of the one or more bits may indicate value of 1 in accordance with the update being transmitted at least the threshold duration prior to the update occurring. Additionally, or alternatively, the indication of the update may be associated with the one or more AIDs, from the multiple AIDs, reserved for indicating upcoming updates in accordance with the configuration information.

In some other implementations, the AP 102-b may transmit the indication of the update via an additional frame different than the beacon frame and different than the probe response frame, where the additional frame is transmitted a fixed duration offset from (such as after or before) the beacon frame, the probe response frame, or both. In such implementations, the additional frame may be a Multi-Link Update Notification frame including a Reconfiguration Multi-Link element indicative of the update.

In some implementations, to transmit the indication of the update, the AP 102-b may transmit multiple repetitions of the update until the update occurs or until the AP 102-b determines that one or more STAs 104 from the set of STAs 104, including at least the STA 104-b, have received the indication of the update, where the update is applicable to the one or more STAs 104 from the set of STAs 104.

Additionally, or alternatively, the indication of the update (or another indication) may include an indication of one or more communication links for which the update is applicable. In such implementations, the indication of the update may further include one or more bits that indicate one or more link identifiers associated with the one or more communication links for which the update is applicable, an indication that the one or more communication links for which the update is applicable include multiple communication links, or both. In some implementations, the AP 102-b may transmit a respective instance of the indication of the update via each communication link of multiple communication links, where a first instance of the indication of the update transmitted via the one or more communication links, of the multiple communication links, for which the update is applicable may include additional information associated with the update in accordance with the update being applicable for the one or more communication links

In some implementations (such as when the indication of the one or more communication links is not in the indication of the update), a frame may include a first portion indicating the update is to occur and a second portion (such as an RNR element) indicating the one or more communication links for which the update is applicable. Additionally, or alternatively, the AP 102-b and another AP 102 may be associated with an MLD, such that the indication of the update further indicates that the one or more communication links for which the update is applicable are associated with the other AP 102.

In some implementations, the indication of the update may include an indication of one or more first values of the one or more parameters prior to the update, an indication of one or more second values of the one or more parameters after the update, or both. In some implementations, the AP 102-b may indicate the one or more first values via respective first instances of one or more sub-elements, the AP 102-b may indicate the one or more second values via respective second instances of the one or more sub-elements, and a same frame may include both the respective first instances and the respective second instances. In some other implementations, the AP 102-b may indicate the one or more second values via respective single instances of one or more sub-elements.

In some implementations, the update may be associated with a transition phase, where the AP 102-b, the STA 104-b, or both, may be restricted from communication during the transition phase. In such implementations, the transition phase may begin at time at which the indication of the update is received and ends at the time at which the update occurs, begins at the time at which the update occurs and ends at a time at which the indication of the update is processed by the STA 104-b, or both. Additionally, or alternatively, the AP 102-b may communicate one or more indications of whether the AP 102-b, the STA 104-b, or both, may be restricted from communicating during the transition phase.

At 420, the AP 102-b may communicate with the STA 104-b in accordance with the update to the one or more parameters after the time at which the update is to occur.

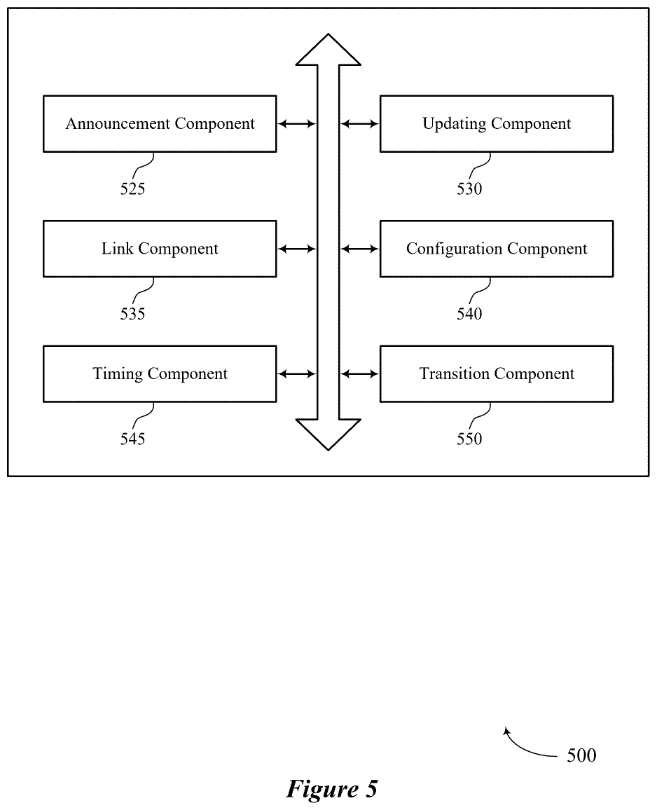

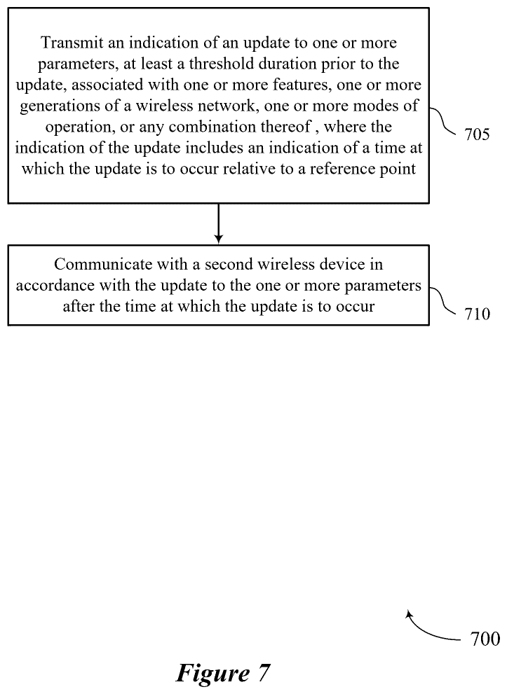

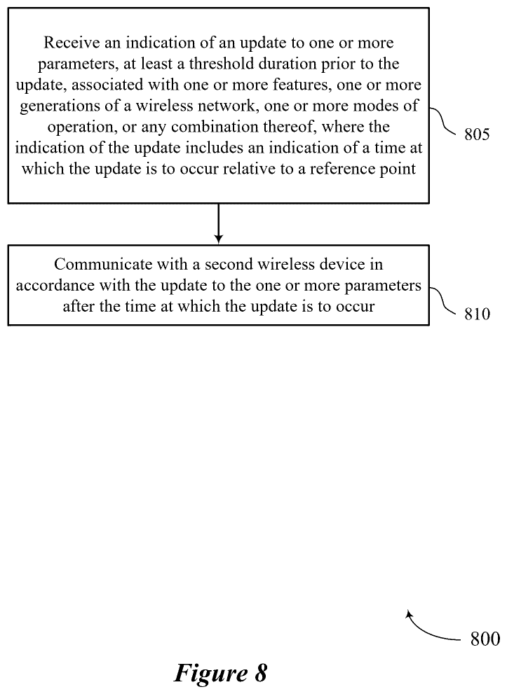

FIG. 5 shows a block diagram of an example wireless communication device 500 that supports advanced notification of critical updates. In some implementations, the wireless communication device 500 is configured to perform the processes 700 and 800 described with reference to FIGS. 7 and 8, respectively. The wireless communication device 500 may include one or more chips, SoCs, chipsets, packages, components or devices that individually or collectively constitute or include a processing system. The processing system may interface with other components of the wireless communication device 500, and may generally process information (such as inputs or signals) received from such other components and output information (such as outputs or signals) to such other components. In some aspects, an implementation chip may include a processing system, a first interface to output or transmit information and a second interface to receive or obtain information. For example, the first interface may refer to an interface between the processing system of the chip and a transmission component, such that the wireless communication device 500 may transmit the information output from the chip. In such an implementation, the second interface may refer to an interface between the processing system of the chip and a reception component, such that the wireless communication device 500 may receive information that is passed to the processing system. In some such implementations, the first interface also may obtain information, such as from the transmission component, and the second interface also may output information, such as to the reception component.

The processing system of the wireless communication device 500 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 500 can be configurable or configured for use in an AP, such as the AP 102 described with reference to FIG. 1. In some other implementations, the wireless communication device 500 can be an AP that includes such a processing system and other components including multiple antennas. The wireless communication device 500 is capable of transmitting and receiving wireless communications in the form of, For example, wireless packets. For example, the wireless communication device 500 can be configurable or configured to transmit and receive packets in the form of physical layer PPDUs and MPDUs conforming to one or more of the IEEE 802.11 family of wireless communication protocol standards. In some other implementations, the wireless communication device 500 can be configurable or configured to transmit and receive signals and communications conforming to one or more 3GPP specifications including those for 5G NR or 6G. In some implementations, the wireless communication device 500 also includes or can be coupled with one or more application processors which may be further coupled with one or more other memories. In some implementations, the wireless communication device 500 further includes at least one external network interface coupled with the processing system that enables communication with a core network or backhaul network that enables the wireless communication device 500 to gain access to external networks including the Internet.

The wireless communication device 500 includes an announcement component 525, an updating component 530, a link component 535, a configuration component 540, a timing component 545, and a transition component 550. Portions of one or more of the announcement component 525, the updating component 530, the link component 535, the configuration component 540, the timing component 545, and the transition component 550 may be implemented at least in part in hardware or firmware. For example, one or more of the announcement component 525, the updating component 530, the link component 535, the configuration component 540, the timing component 545, and the transition component 550 may be implemented at least in part by at least a processor or a modem. In some implementations, portions of one or more of the announcement component 525, the updating component 530, the link component 535, the configuration component 540, the timing component 545, and the transition component 550 may be implemented at least in part by a processor and software in the form of processor-executable code stored in memory.

The wireless communication device 500 may support wireless communications in accordance with implementations as disclosed herein. The announcement component 525 is configurable or configured to transmit an indication of an update to one or more parameters, at least a threshold duration prior to the update, associated with one or more features, one or more generations of a wireless network, one or more modes of operation, or any combination thereof, where the indication of the update includes an indication of a time at which the update is to occur relative to a reference point. The updating component 530 is configurable or configured to communicate with a second wireless device in accordance with the update to the one or more parameters after the time at which the update is to occur.

In some implementations, a difference between the time at which the update is to occur and the reference point is greater than or equal to the threshold duration. In some implementations, the reference point is a time at which the indication of the update is received or is an absolute time reference, or both.

In some implementations, the first wireless device is associated with a set of multiple additional wireless devices, including at least the second wireless device. In some implementations, the indication of the update is transmitted to one or more additional wireless devices of the set of multiple additional wireless devices, including at least the second wireless device.

In some implementations, the indication of the update is transmitted to the one or more additional wireless devices that are capable of supporting at least a first generation of the one or more generations of the wireless network, are capable of supporting at least one of the one or more features for which the update is applicable, have enabled at least one of the one or more features for which the update is applicable, support one or more communication links for which the update is applicable, or any combination thereof.

In some implementations, transmission of the indication of the update is in accordance with the update being from a set of multiple updates defined as critical updates, in accordance with the update being associated with at least a first generation of the one or more generations of the wireless network, in accordance with the update being from a subset of the set of multiple updates, in accordance with the update affecting a first set of multiple additional wireless devices associated with a multiple BSS identifier (MBSSID) set, in accordance with the update affecting a second set of multiple additional wireless devices associated with a cohosted set, in accordance with the update being from one or more updates indicated by the second wireless device, or any combination thereof.

In some implementations, the indication of the update is transmitted via one or more bits in a capability information field in a beacon frame, in a probe response frame, or both.

In some implementations, a first bit of the one or more bits indicates a value of 1 in accordance with the update being transmitted at least the threshold duration prior to the update.

In some implementations, the configuration component 540 is configurable or configured to transmit, to the second wireless device, configuration information associated with the one or more bits, the capability information field, or both, where transmission of the indication of the update is in accordance with the configuration information.

In some implementations, the indication of the update is associated with one or more AIDs, from a set of multiple AIDs, reserved for indicating upcoming updates.

In some implementations, the configuration component 540 is configurable or configured to transmit, to the second wireless device, configuration information associated with the one or more AIDs, where transmission of the indication of the update is in accordance with the configuration information.

In some implementations, the indication of the update is transmitted via an additional frame different than a beacon frame and different than a probe response frame. In some implementations, the additional frame is transmitted a fixed duration offset from the beacon frame, the probe response frame, or both.

In some implementations, the additional frame is a Multi-Link Update Notification frame including a Reconfiguration Multi-Link element indicative of the update.

In some implementations, to support transmitting the indication of the update, the announcement component 525 is configurable or configured to transmit a set of multiple repetitions of the update until the update occurs or until the first wireless device determines that one or more additional wireless devices of a set of multiple additional wireless devices, including at least the second wireless device, have received the indication of the update, where the update is applicable to the one or more additional wireless devices of the set of multiple additional wireless devices.

In some implementations, the link component 535 is configurable or configured to transmit an indication of one or more communication links for which the update is applicable.

In some implementations, the indication of the update further includes one or more bits that indicate one or more link identifiers associated with the one or more communication links for which the update is applicable, an indication that the one or more communication links for which the update is applicable include a set of multiple communication links, or both.

In some implementations, a frame includes a first portion indicating the update is to occur and a second portion indicating the one or more communication links for which the update is applicable.

In some implementations, the second portion of the frame includes a reduced neighbor report element.

In some implementations, the first wireless device and a third wireless device are associated with a multi-link device. In some implementations, the indication of the update further indicates that the one or more communication links for which the update is applicable are associated with the third wireless device.

In some implementations, a respective instance of the indication of the update is transmitted via each communication link of a set of multiple communication links. In some implementations, a first instance of the indication of the update transmitted via one or more communication links, of the set of multiple communication links, for which the update is applicable includes additional information associated with the update in accordance with the update being applicable for the one or more communication links.

In some implementations, the indication of the update includes an indication of one or more first values of the one or more parameters prior to the update, an indication of one or more second values of the one or more parameters after the update, or both.

In some implementations, the one or more first values are indicated via respective first instances of one or more sub-elements. In some implementations, the one or more second values are indicated via respective second instances of the one or more sub-elements. In some implementations, a same frame includes both the respective first instances and the respective second instances.

In some implementations, the one or more second values are indicated via respective instances of one or more sub-elements.

In some implementations, the threshold duration is in accordance with a capability of each additional wireless device of a set of multiple additional wireless devices, including at least the second wireless device, to wake up at least once prior to the time at which the update is to occur, in accordance with a threshold listen interval out of the set of multiple additional wireless devices, or any combination thereof.

In some implementations, the threshold duration is a longest threshold duration out of a set of multiple threshold durations indicated by a set of multiple additional wireless devices, including at least the second wireless device.

In some implementations, the timing component 545 is configurable or configured to receive, from each additional wireless device of the set of multiple additional wireless devices, a respective indication a respective threshold duration of the set of multiple threshold durations.

In some implementations, the update is associated with a transition phase. In some implementations, the first wireless device, the second wireless device, or both, may be restricted from communicating during the transition phase.

In some implementations, the transition phase begins at time at which the indication of the update is received and ends at the time at which the update occurs, begins at the time at which the update occurs and ends at a time at which the indication of the update is processed by the second wireless device, or both.

In some implementations, the transition component 550 is configurable or configured to communicate one or more indications of whether the first wireless device, the second wireless device, or both, are restricted from communicating during the transition phase.

In some implementations, the announcement component 525 is configurable or configured to transmit a signal indicative of a set of multiple future updates, including at least the update.

In some implementations, the update associated with the time relative to the reference point is an earliest occurring update of the set of multiple future updates.

In some implementations, the signal includes an indication of a respective time at which each update of the set of multiple future updates are to occur relative to the reference point.

Additionally, or alternatively, the wireless communication device 500 may support wireless communications in accordance with implementations as disclosed herein. In some implementations, the updating component 530 is configurable or configured to receive an indication of an update to one or more parameters, at least a threshold duration prior to the update, associated with one or more features, one or more generations of a wireless network, one or more modes of operation, or any combination thereof, where the indication of the update includes an indication of a time at which the update is to occur relative to a reference point. In some implementations, the updating component 530 is configurable or configured to communicate with a second wireless device in accordance with the update to the one or more parameters after the time at which the update is to occur.

In some implementations, a difference between the time at which the update is to occur and the reference point is greater than or equal to the threshold duration. In some implementations, the reference point is a time at which the indication of the update is received or is an absolute time reference, or both.

In some implementations, the first wireless device is from a set of multiple additional wireless devices. In some implementations, the indication of the update is transmitted to one or more additional wireless devices of the set of multiple additional wireless devices, including at least the first wireless device.

In some implementations, reception of the indication of the update by the first wireless device is in accordance with the first wireless device being capable of supporting at least a first generation of the one or more generations of the wireless network, are capable of supporting at least one of the one or more features for which the update is applicable, have enabled at least one of the one or more features for which the update is applicable, support one or more communication links for which the update is applicable, or any combination thereof.

In some implementations, reception of the indication of the update is in accordance with the update being from a set of multiple updates defined as critical updates, in accordance with the update being associated with at least a first generation of the one or more generations of the wireless network, in accordance with the update being from a subset of the set of multiple updates, in accordance with the update affecting a first set of multiple additional wireless devices associated with a multiple BSS identifier (MBSSID) set, in accordance with the update affecting a second set of multiple additional wireless devices associated with a cohosted set, in accordance with the update being from one or more updates indicated by the first wireless device, or any combination thereof.

In some implementations, the indication of the update is transmitted via one or more bits in a capability information field in a beacon frame, in a probe response frame, or both.

In some implementations, a first bit of the one or more bits indicates a value of 1 in accordance with the update being received at least the threshold duration prior to the update.

In some implementations, the configuration component 540 is configurable or configured to receive configuration information associated with the one or more bits, the capability information field, or both, where reception of the indication of the update is in accordance with the configuration information.

In some implementations, the indication of the update is associated with one or more AIDs, from a set of multiple AIDs, reserved for indicating upcoming updates.

In some implementations, the configuration component 540 is configurable or configured to receive configuration information associated with the one or more AIDs, where reception of the indication of the update is in accordance with the configuration information.

In some implementations, the indication of the update is transmitted via an additional frame different than a beacon frame and different than a probe response frame. In some implementations, the additional frame is received a fixed duration offset from the beacon frame, the probe response frame, or both.

In some implementations, the additional frame is a Multi-Link Update Notification frame including a Reconfiguration Multi-Link element indicative of the update.

In some implementations, to support receiving the indication of the update, the updating component 530 is configurable or configured to receive a set of multiple repetitions of the update until the update occurs or until one or more additional wireless devices of a set of multiple additional wireless devices, including at least the first wireless device, have received the indication of the update, where the update is applicable to the one or more additional wireless devices of the set of multiple additional wireless devices.

In some implementations, the link component 535 is configurable or configured to receive an indication of one or more communication links for which the update is applicable.

In some implementations, the indication of the update further includes one or more bits that indicate one or more link identifiers associated with the one or more communication links for which the update is applicable, an indication that the one or more communication links for which the update is applicable include a set of multiple communication links, or both.

In some implementations, a frame includes a first portion indicating the update is to occur and a second portion indicating the one or more communication links for which the update is applicable.

In some implementations, the second portion of the frame includes a reduced neighbor report element.

In some implementations, the second wireless device and a third wireless device are associated with a multi-link device. In some implementations, the indication of the update further indicates that the one or more communication links for which the update is applicable are associated with the third wireless device.

In some implementations, a respective instance of the indication of the update is transmitted via each communication link of a set of multiple communication links. In some implementations, a first instance of the indication of the update transmitted via one or more communication links, of the set of multiple communication links, for which the update is applicable includes additional information associated with the update in accordance with the update being applicable for the one or more communication links.

In some implementations, the indication of the update includes an indication of one or more first values of the one or more parameters prior to the update, an indication of one or more second values of the one or more parameters after the update, or both.

In some implementations, the one or more first values are indicated via respective first instances of one or more sub-elements. In some implementations, the one or more second values are indicated via respective second instances of the one or more sub-elements. In some implementations, a same frame includes both the respective first instances and the respective second instances.

In some implementations, the one or more second values are indicated via respective instances of one or more sub-elements.

In some implementations, the threshold duration is in accordance with a capability of each additional wireless device of a set of multiple additional wireless devices, including at least the first wireless device, to wake up at least once prior to the time at which the update is to occur, in accordance with a threshold listen interval out of the set of multiple additional wireless devices, or any combination thereof.

In some implementations, the threshold duration is a longest threshold duration out of a set of multiple threshold durations indicated by a set of multiple additional wireless devices including at least the first wireless device.

In some implementations, the timing component 545 is configurable or configured to transmit an indication of a threshold duration, of the set of multiple threshold durations, associated with the first wireless device.

In some implementations, the update is associated with a transition phase. In some implementations, the first wireless device, the second wireless device, or both, may be restricted from communicating during the transition phase.

In some implementations, the transition phase begins at time at which the indication of the update is received and ends at the time at which the update occurs, begins at the time at which the update occurs and ends at a time at which the indication of the update is processed by the second wireless device, or both.

In some implementations, the transition component 550 is configurable or configured to communicate one or more indications of whether the first wireless device, the second wireless device, or both, are restricted from communicating during the transition phase.

In some implementations, the updating component 530 is configurable or configured to receive a signal indicative of a set of multiple future updates, including at least the update.

In some implementations, the update associated with the time relative to the reference point is an earliest occurring update of the set of multiple future updates.

In some implementations, the signal includes an indication of a respective time at which each update of the set of multiple future updates are to occur relative to the reference point.

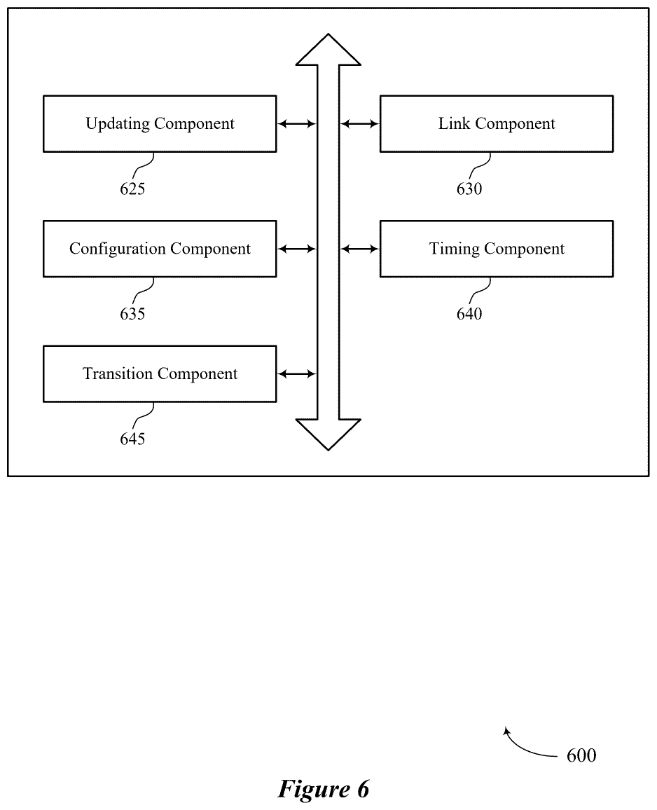

FIG. 6 shows a block diagram of an example wireless communication device 600 that supports advanced notification of critical updates. In some implementations, the wireless communication device 600 is configured to perform the process 800 described with reference to FIG. 8. The wireless communication device 600 may include one or more chips, SoCs, chipsets, packages, components or devices that individually or collectively constitute or include a processing system. The processing system may interface with other components of the wireless communication device 600, and may generally process information (such as inputs or signals) received from such other components and output information (such as outputs or signals) to such other components. In some aspects, an implementation chip may include a processing system, a first interface to output or transmit information and a second interface to receive or obtain information. For example, the first interface may refer to an interface between the processing system of the chip and a transmission component, such that the wireless communication device 600 may transmit the information output from the chip. In such an implementation, the second interface may refer to an interface between the processing system of the chip and a reception component, such that the wireless communication device 600 may receive information that is passed to the processing system. In some such implementations, the first interface also may obtain information, such as from the transmission component, and the second interface also may output information, such as to the reception component.

The processing system of the wireless communication device 600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 600 can be configurable or configured for use in a STA, such as the STA 104 described with reference to FIG. 1. In some other implementations, the wireless communication device 600 can be a STA that includes such a processing system and other components including multiple antennas. The wireless communication device 600 is capable of transmitting and receiving wireless communications in the form of, For example, wireless packets. For example, the wireless communication device 600 can be configurable or configured to transmit and receive packets in the form of physical layer PPDUs and MPDUs conforming to one or more of the IEEE 802.11 family of wireless communication protocol standards. In some other implementations, the wireless communication device 600 can be configurable or configured to transmit and receive signals and communications conforming to one or more 3GPP specifications including those for 5G NR or 6G. In some implementations, the wireless communication device 600 also includes or can be coupled with one or more application processors which may be further coupled with one or more other memories. In some implementations, the wireless communication device 600 further includes a user interface (UI) (such as a touchscreen or keypad) and a display, which may be integrated with the UI to form a touchscreen display that is coupled with the processing system. In some implementations, the wireless communication device 600 may further include one or more sensors such as, For example, one or more inertial sensors, accelerometers, temperature sensors, pressure sensors, or altitude sensors, that are coupled with the processing system.

The wireless communication device 600 includes an updating component 625, a link component 630, a configuration component 635, a timing component 640, and a transition component 645. Portions of one or more of the updating component 625, the link component 630, the configuration component 635, the timing component 640, and the transition component 645 may be implemented at least in part in hardware or firmware. For example, one or more of the updating component 625, the link component 630, the configuration component 635, the timing component 640, and the transition component 645 may be implemented at least in part by at least a processor or a modem. In some implementations, portions of one or more of the updating component 625, the link component 630, the configuration component 635, the timing component 640, and the transition component 645 may be implemented at least in part by a processor and software in the form of processor-executable code stored in memory.

The wireless communication device 600 may support wireless communications in accordance with implementations as disclosed herein. The updating component 625 is configurable or configured to receive an indication of an update to one or more parameters, at least a threshold duration prior to the update, associated with one or more features, one or more generations of a wireless network, one or more modes of operation, or any combination thereof, where the indication of the update includes an indication of a time at which the update is to occur relative to a reference point. In some implementations, the updating component 625 is configurable or configured to communicate with a second wireless device in accordance with the update to the one or more parameters after the time at which the update is to occur.

In some implementations, a difference between the time at which the update is to occur and the reference point is greater than or equal to the threshold duration. In some implementations, the reference point is a time at which the indication of the update is received or is an absolute time reference, or both.

In some implementations, the first wireless device is from a set of multiple additional wireless devices. In some implementations, the indication of the update is transmitted to one or more additional wireless devices of the set of multiple additional wireless devices, including at least the first wireless device.

In some implementations, reception of the indication of the update by the first wireless device is in accordance with the first wireless device being capable of supporting at least a first generation of the one or more generations of the wireless network, are capable of supporting at least one of the one or more features for which the update is applicable, have enabled at least one of the one or more features for which the update is applicable, support one or more communication links for which the update is applicable, or any combination thereof.

In some implementations, reception of the indication of the update is in accordance with the update being from a set of multiple updates defined as critical updates, in accordance with the update being associated with at least a first generation of the one or more generations of the wireless network, in accordance with the update being from a subset of the set of multiple updates, in accordance with the update affecting a first set of multiple additional wireless devices associated with a multiple BSS identifier (MBSSID) set, in accordance with the update affecting a second set of multiple additional wireless devices associated with a cohosted set, in accordance with the update being from one or more updates indicated by the first wireless device, or any combination thereof.

In some implementations, the indication of the update is transmitted via one or more bits in a capability information field in a beacon frame, in a probe response frame, or both.

In some implementations, a first bit of the one or more bits indicates a value of 1 in accordance with the update being received at least the threshold duration prior to the update.

In some implementations, the configuration component 635 is configurable or configured to receive configuration information associated with the one or more bits, the capability information field, or both, where reception of the indication of the update is in accordance with the configuration information.

In some implementations, the indication of the update is associated with one or more AIDs, from a set of multiple AIDs, reserved for indicating upcoming updates.

In some implementations, the configuration component 635 is configurable or configured to receive configuration information associated with the one or more AIDs, where reception of the indication of the update is in accordance with the configuration information.

In some implementations, the indication of the update is transmitted via an additional frame different than a beacon frame and different than a probe response frame. In some implementations, the additional frame is received a fixed duration offset from the beacon frame, the probe response frame, or both.

In some implementations, the additional frame is a Multi-Link Update Notification frame including a Reconfiguration Multi-Link element indicative of the update.

In some implementations, to support receiving the indication of the update, the updating component 625 is configurable or configured to receive a set of multiple repetitions of the update until the update occurs or until one or more additional wireless devices of a set of multiple additional wireless devices, including at least the first wireless device, have received the indication of the update, where the update is applicable to the one or more additional wireless devices of the set of multiple additional wireless devices.

In some implementations, the link component 630 is configurable or configured to receive an indication of one or more communication links for which the update is applicable.

In some implementations, the indication of the update further includes one or more bits that indicate one or more link identifiers associated with the one or more communication links for which the update is applicable, an indication that the one or more communication links for which the update is applicable include a set of multiple communication links, or both.

In some implementations, a frame includes a first portion indicating the update is to occur and a second portion indicating the one or more communication links for which the update is applicable.

In some implementations, the second portion of the frame includes a reduced neighbor report element.

In some implementations, the second wireless device and a third wireless device are associated with a multi-link device. In some implementations, the indication of the update further indicates that the one or more communication links for which the update is applicable are associated with the third wireless device.

In some implementations, a respective instance of the indication of the update is transmitted via each communication link of a set of multiple communication links. In some implementations, a first instance of the indication of the update transmitted via one or more communication links, of the set of multiple communication links, for which the update is applicable includes additional information associated with the update in accordance with the update being applicable for the one or more communication links.

In some implementations, the indication of the update includes an indication of one or more first values of the one or more parameters prior to the update, an indication of one or more second values of the one or more parameters after the update, or both.

In some implementations, the one or more first values are indicated via respective first instances of one or more sub-elements. In some implementations, the one or more second values are indicated via respective second instances of the one or more sub-elements. In some implementations, a same frame includes both the respective first instances and the respective second instances.

In some implementations, the one or more second values are indicated via respective instances of one or more sub-elements.

In some implementations, the threshold duration is in accordance with a capability of each additional wireless device of a set of multiple additional wireless devices, including at least the first wireless device, to wake up at least once prior to the time at which the update is to occur, in accordance with a threshold listen interval out of the set of multiple additional wireless devices, or any combination thereof.

In some implementations, the threshold duration is a longest threshold duration out of a set of multiple threshold durations indicated by a set of multiple additional wireless devices including at least the first wireless device.

In some implementations, the timing component 640 is configurable or configured to transmit an indication of a threshold duration, of the set of multiple threshold durations, associated with the first wireless device.

In some implementations, the update is associated with a transition phase. In some implementations, the first wireless device, the second wireless device, or both, may be restricted from communicating during the transition phase.

In some implementations, the transition phase begins at time at which the indication of the update is received and ends at the time at which the update occurs, begins at the time at which the update occurs and ends at a time at which the indication of the update is processed by the second wireless device, or both.

In some implementations, the transition component 645 is configurable or configured to communicate one or more indications of whether the first wireless device, the second wireless device, or both, are restricted from communicating during the transition phase.

In some implementations, the updating component 625 is configurable or configured to receive a signal indicative of a set of multiple future updates, including at least the update.

In some implementations, the update associated with the time relative to the reference point is an earliest occurring update of the set of multiple future updates.

In some implementations, the signal includes an indication of a respective time at which each update of the set of multiple future updates are to occur relative to the reference point.

FIG. 7 shows a flowchart illustrating an example process 700 performable by or at a first wireless device that supports advanced notification of critical updates. The operations of the process 700 may be implemented by a first wireless device or its components as described herein. For example, the process 700 may be performed by a wireless communication device, such as the wireless communication device 500 described with reference to FIG. 5, operating as or within a wireless AP. In some implementations, the process 700 may be performed by a wireless AP, such as one of the APs 102 described with reference to FIG. 1.

In some implementations, in 705, the first wireless device may transmit an indication of an update to one or more parameters, at least a threshold duration prior to the update, associated with one or more features, one or more generations of a wireless network, one or more modes of operation, or any combination thereof, where the indication of the update includes an indication of a time at which the update is to occur relative to a reference point. The operations of 705 may be performed in accordance with implementations as disclosed herein. In some implementations, aspects of the operations of 705 may be performed by an announcement component 525 as described with reference to FIG. 5.

In some implementations, in 710, the first wireless device may communicate with a second wireless device in accordance with the update to the one or more parameters after the time at which the update is to occur. The operations of 710 may be performed in accordance with implementations as disclosed herein. In some implementations, aspects of the operations of 710 may be performed by an updating component 530 as described with reference to FIG. 5.

FIG. 8 shows a flowchart illustrating an example process 800 performable by or at a first wireless device that supports advanced notification of critical updates. The operations of the process 800 may be implemented by a first wireless device or its components as described herein. For example, the process 800 may be performed by a wireless communication device, such as the wireless communication device 500 described with reference to FIG. 5, operating as or within a wireless AP or a wireless STA. In some implementations, the process 800 may be performed by a wireless AP or a wireless STA, such as one of the APs 102 or the STAs 104 described with reference to FIG. 1.

In some implementations, in 805, the first wireless device may receive an indication of an update to one or more parameters, at least a threshold duration prior to the update, associated with one or more features, one or more generations of a wireless network, one or more modes of operation, or any combination thereof, where the indication of the update includes an indication of a time at which the update is to occur relative to a reference point. The operations of 805 may be performed in accordance with implementations as disclosed herein. In some implementations, aspects of the operations of 805 may be performed by an updating component 530 or an updating component 625 as described with reference to FIGS. 5 and 6.

In some implementations, in 810, the first wireless device may communicate with a second wireless device in accordance with the update to the one or more parameters after the time at which the update is to occur. The operations of 810 may be performed in accordance with implementations as disclosed herein. In some implementations, aspects of the operations of 810 may be performed by an updating component 530 or an updating component 625 as described with reference to FIGS. 5 and 6.

Implementation implementations are described in the following numbered clauses:

The following provides an overview of aspects of the present disclosure:
Aspect 1: A method for wireless communications at a first wireless device, including: transmitting an indication of an update to one or more parameters, at least a threshold duration prior to the update, associated with one or more features, one or more generations of a wireless network, one or more modes of operation, or any combination thereof, where the indication of the update includes an indication of a time at which the update is to occur relative to a reference point; and communicating with a second wireless device in accordance with the update to the one or more parameters after the time at which the update is to occur.
Aspect 2: The method of aspect 1, where a difference between the time at which the update is to occur and the reference point is greater than or equal to the threshold duration, the reference point is a time at which the indication of the update is received or is an absolute time reference, or both.
Aspect 3: The method of any of aspects 1 through 2, where the first wireless device is associated with a plurality of additional wireless devices, including at least the second wireless device, and the indication of the update is transmitted to one or more additional wireless devices of the plurality of additional wireless devices, including at least the second wireless device.
Aspect 4: The method of aspect 3, where the indication of the update is transmitted to the one or more additional wireless devices that are capable of supporting at least a first generation of the one or more generations of the wireless network, are capable of supporting at least one of the one or more features for which the update is applicable, have enabled at least one of the one or more features for which the update is applicable, support one or more communication links for which the update is applicable, or any combination thereof.

Aspect 5: The method of any of aspects 1 through 4, where transmission of the indication of the update is in accordance with the update being from a plurality of updates defined as critical updates, in accordance with the update being associated with at least a first generation of the one or more generations of the wireless network, in accordance with the update being from a subset of the plurality of updates, in accordance with the update affecting a first plurality of additional wireless devices associated with a MBSSID set, in accordance with the update affecting a second plurality of additional wireless devices associated with a cohosted set, in accordance with the update being from one or more updates indicated by the second wireless device, or any combination thereof.

Aspect 6: The method of any of aspects 1 through 5, where the indication of the update is transmitted via one or more bits in a capability information field in a beacon frame, in a probe response frame, or both.

Aspect 7: The method of aspect 6, where a first bit of the one or more bits indicates a value of 1 in accordance with the update being transmitted at least the threshold duration prior to the update.

Aspect 8: The method of any of aspects 6 through 7, further including:
transmitting, to the second wireless device, configuration information associated with the one or more bits, the capability information field, or both, where transmission of the indication of the update is in accordance with the configuration information.
Aspect 9: The method of any of aspects 1 through 8, where the indication of the update is associated with one or more AIDs, from a plurality of AIDs, reserved for indicating upcoming updates.
Aspect 10: The method of aspect 9, further including: transmitting, to the second wireless device, configuration information associated with the one or more AIDs, where transmission of the indication of the update is in accordance with the configuration information.
Aspect 11: The method of any of aspects 1 through 10, where the indication of the update is transmitted via an additional frame different than a beacon frame and different than a probe response frame, and the additional frame is transmitted a fixed duration offset from the beacon frame, the probe response frame, or both.
Aspect 12: The method of aspect 11, where the additional frame is a Multi-Link Update Notification frame including a Reconfiguration Multi-Link element indicative of the update.

Aspect 13: The method of any of aspects 1 through 12, where transmitting the indication of the update includes: transmitting a plurality of repetitions of the update until the update occurs or until the first wireless device determines that one or more additional wireless devices of a plurality of additional wireless devices, including at least the second wireless device, have received the indication of the update, where the update is applicable to the one or more additional wireless devices of the plurality of additional wireless devices.

Aspect 14: The method of any of aspects 1 through 13, further including:
transmitting an indication of one or more communication links for which the update is applicable.
Aspect 15: The method of aspect 14, where the indication of the update further includes one or more bits that indicate one or more link identifiers associated with the one or more communication links for which the update is applicable, an indication that the one or more communication links for which the update is applicable include a plurality of communication links, or both.
Aspect 16: The method of any of aspects 14 through 15, where a frame includes a first portion indicating the update is to occur and a second portion indicating the one or more communication links for which the update is applicable.
Aspect 17: The method of aspect 16, where the second portion of the frame includes a reduced neighbor report element.
Aspect 18: The method of any of aspects 14 through 17, where the first wireless device and a third wireless device are associated with a multi-link device, and the indication of the update further indicates that the one or more communication links for which the update is applicable are associated with the third wireless device.
Aspect 19: The method of any of aspects 1 through 18, where a respective instance of the indication of the update is transmitted via each communication link of a plurality of communication links, and a first instance of the indication of the update transmitted via one or more communication links, of the plurality of communication links, for which the update is applicable includes additional information associated with the update in accordance with the update being applicable for the one or more communication links.
Aspect 20: The method of any of aspects 1 through 19, where the indication of the update includes an indication of one or more first values of the one or more parameters prior to the update, an indication of one or more second values of the one or more parameters after the update, or both.
Aspect 21: The method of aspect 20, where the one or more first values are indicated via respective first instances of one or more sub-elements, the one or more second values are indicated via respective second instances of the one or more sub-elements, and a same frame includes both the respective first instances and the respective second instances.
Aspect 22: The method of any of aspects 20 through 21, where the one or more second values are indicated via respective instances of one or more sub-elements.
Aspect 23: The method of any of aspects 1 through 22, where the threshold duration is in accordance with a capability of each additional wireless device of a plurality of additional wireless devices, including at least the second wireless device, to wake up at least once prior to the time at which the update is to occur, in accordance with a threshold listen interval out of the plurality of additional wireless devices, or any combination thereof.
Aspect 24: The method of any of aspects 1 through 23, where the threshold duration is a longest threshold duration out of a plurality of threshold durations indicated by a plurality of additional wireless devices, including at least the second wireless device.
Aspect 25: The method of aspect 24, further including: receiving, from each additional wireless device of the plurality of additional wireless devices, a respective indication a respective threshold duration of the plurality of threshold durations.
Aspect 26: The method of any of aspects 1 through 25, where the update is associated with a transition phase, and the first wireless device, the second wireless device, or both, may be restricted from communicating during the transition phase.
Aspect 27: The method of aspect 26, where the transition phase begins at time at which the indication of the update is received and ends at the time at which the update occurs, begins at the time at which the update occurs and ends at a time at which the indication of the update is processed by the second wireless device, or both.
Aspect 28: The method of any of aspects 26 through 27, further including: communicating one or more indications of whether the first wireless device, the second wireless device, or both, are restricted from communicating during the transition phase.
Aspect 29: The method of any of aspects 1 through 28, further including: transmitting a signal indicative of a plurality of future updates, including at least the update.
Aspect 30: The method of aspect 29, where the update associated with the time relative to the reference point is an earliest occurring update of the plurality of future updates.

Aspect 31: The method of any of aspects 29 through 30, where the signal includes an indication of a respective time at which each update of the plurality of future updates are to occur relative to the reference point.

Aspect 32: A method for wireless communications at a first wireless device, including: receiving an indication of an update to one or more parameters, at least a threshold duration prior to the update, associated with one or more features, one or more generations of a wireless network, one or more modes of operation, or any combination thereof, where the indication of the update includes an indication of a time at which the update is to occur relative to a reference point; and communicating with a second wireless device in accordance with the update to the one or more parameters after the time at which the update is to occur.

Aspect 33: The method of aspect 32, where a difference between the time at which the update is to occur and the reference point is greater than or equal to the threshold duration, the reference point is a time at which the indication of the update is received or is an absolute time reference, or both.

Aspect 34: The method of any of aspects 32 through 33, where the first wireless device is from a plurality of additional wireless devices, and the indication of the update is transmitted to one or more additional wireless devices of the plurality of additional wireless devices, including at least the first wireless device.

Aspect 35: The method of aspect 34, where reception of the indication of the update by the first wireless device is in accordance with the first wireless device being capable of supporting at least a first generation of the one or more generations of the wireless network, are capable of supporting at least one of the one or more features for which the update is applicable, have enabled at least one of the one or more features for which the update is applicable, support one or more communication links for which the update is applicable, or any combination thereof.

Aspect 36: The method of any of aspects 32 through 35, where reception of the indication of the update is in accordance with the update being from a plurality of updates defined as critical updates, in accordance with the update being associated with at least a first generation of the one or more generations of the wireless network, in accordance with the update being from a subset of the plurality of updates, in accordance with the update affecting a first plurality of additional wireless devices associated with a MBSSID set, in accordance with the update affecting a second plurality of additional wireless devices associated with a cohosted set, in accordance with the update being from one or more updates indicated by the first wireless device, or any combination thereof.

Aspect 37: The method of any of aspects 32 through 36, where the indication of the update is transmitted via one or more bits in a capability information field in a beacon frame, in a probe response frame, or both.

Aspect 38: The method of aspect 37, where a first bit of the one or more bits indicates a value of 1 in accordance with the update being received at least the threshold duration prior to the update.
Aspect 39: The method of any of aspects 37 through 38, further including: receiving configuration information associated with the one or more bits, the capability information field, or both, where reception of the indication of the update is in accordance with the configuration information.
Aspect 40: The method of any of aspects 32 through 39, where the indication of the update is associated with one or more AIDs, from a plurality of AIDs, reserved for indicating upcoming updates.
Aspect 41: The method of aspect 40, further including: receiving configuration information associated with the one or more AIDs, where reception of the indication of the update is in accordance with the configuration information.
Aspect 42: The method of any of aspects 32 through 41, where the indication of the update is transmitted via an additional frame different than a beacon frame and different than a probe response frame, and the additional frame is received a fixed duration offset from the beacon frame, the probe response frame, or both.
Aspect 43: The method of aspect 42, where the additional frame is a Multi-Link Update Notification frame including a reconfiguration multi-link element indicative of the update.
Aspect 44: The method of any of aspects 32 through 43, where receiving the indication of the update includes: receiving a plurality of repetitions of the update until the update occurs or until one or more additional wireless devices of a plurality of additional wireless devices, including at least the first wireless device, have received the indication of the update, where the update is applicable to the one or more additional wireless devices of the plurality of additional wireless devices.
Aspect 45: The method of any of aspects 32 through 44, further including: receiving an indication of one or more communication links for which the update is applicable.
Aspect 46: The method of aspect 45, where the indication of the update further includes one or more bits that indicate one or more link identifiers associated with the one or more communication links for which the update is applicable, an indication that the one or more communication links for which the update is applicable include a plurality of communication links, or both.
Aspect 47: The method of any of aspects 45 through 46, where a frame includes a first portion indicating the update is to occur and a second portion indicating the one or more communication links for which the update is applicable.
Aspect 48: The method of aspect 47, where the second portion of the frame includes a reduced neighbor report element.
Aspect 49: The method of any of aspects 45 through 48, where the second wireless device and a third wireless device are associated with a multi-link device, and the indication of the update further indicates that the one or more communication links for which the update is applicable are associated with the third wireless device.
Aspect 50: The method of any of aspects 32 through 49, where a respective instance of the indication of the update is transmitted via each communication link of a plurality of communication links, and a first instance of the indication of the update transmitted via one or more communication links, of the plurality of communication links, for which the update is applicable includes additional information associated with the update in accordance with the update being applicable for the one or more communication links.
Aspect 51: The method of aspect 50, where the indication of the update includes an indication of one or more first values of the one or more parameters prior to the update, an indication of one or more second values of the one or more parameters after the update, or both.
Aspect 52: The method of aspect 51, where the one or more first values are indicated via respective first instances of one or more sub-elements, the one or more second values are indicated via respective second instances of the one or more sub-elements, and a same frame includes both the respective first instances and the respective second instances.
Aspect 53: The method of any of aspects 51 through 52, where the one or more second values are indicated via respective instances of one or more sub-elements.
Aspect 54: The method of any of aspects 32 through 53, where the threshold duration is in accordance with a capability of each additional wireless device of a plurality of additional wireless devices, including at least the first wireless device, to wake up at least once prior to the time at which the update is to occur, in accordance with a threshold listen interval out of the plurality of additional wireless devices, or any combination thereof.
Aspect 55: The method of any of aspects 32 through 54, where the threshold duration is a longest threshold duration out of a plurality of threshold durations indicated by a plurality of additional wireless devices including at least the first wireless device.
Aspect 56: The method of aspect 55, further including: transmitting an indication of a threshold duration, of the plurality of threshold durations, associated with the first wireless device.
Aspect 57: The method of any of aspects 32 through 56, where the update is associated with a transition phase, and the first wireless device, the second wireless device, or both, may be restricted from communicating during the transition phase.
Aspect 58: The method of aspect 57, where the transition phase begins at time at which the indication of the update is received and ends at the time at which the update occurs, begins at the time at which the update occurs and ends at a time at which the indication of the update is processed by the second wireless device, or both.
Aspect 59: The method of any of aspects 57 through 58, further including: communicating one or more indications of whether the first wireless device, the second wireless device, or both, are restricted from communicating during the transition phase.
Aspect 60: The method of any of aspects 32 through 59, further including: receiving a signal indicative of a plurality of future updates, including at least the update.
Aspect 61: The method of aspect 60, where the update associated with the time relative to the reference point is an earliest occurring update of the plurality of future updates.
Aspect 62: The method of any of aspects 60 through 61, where the signal includes an indication of a respective time at which each update of the plurality of future updates are to occur relative to the reference point.
Aspect 63: A first wireless device for wireless communications, including one or more memories storing processor-executable code, and one or more processors coupled with the one or more memories and individually or collectively operable to execute the code to cause the first wireless device to perform a method of any of aspects 1 through 31.

Aspect 64: A first wireless device for wireless communications, including at least one means for performing a method of any of aspects 1 through 31.

Aspect 65: A non-transitory computer-readable medium storing code for wireless communications, the code including instructions executable by one or more processors to perform a method of any of aspects 1 through 31.

Aspect 66: A first wireless device for wireless communications, including one or more memories storing processor-executable code, and one or more processors coupled with the one or more memories and individually or collectively operable to execute the code to cause the first wireless device to perform a method of any of aspects 32 through 62.

Aspect 67: A first wireless device for wireless communications, including at least one means for performing a method of any of aspects 32 through 62.

Aspect 68: A non-transitory computer-readable medium storing code for wireless communications, the code including instructions executable by one or more processors to perform a method of any of aspects 32 through 62.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information) or accessing (such as accessing data stored in memory). Additionally, “determining” can include resolving, selecting, obtaining, choosing, establishing and other such similar actions.

As used herein, a phrase referring to “at least one of” or “one or more of” a list of items refers to any combination of those items, including single members. As an implementation, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the implementations disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more implementation processes in the form of a flowchart or flow diagram.

However, other operations that are not depicted can be incorporated in the implementation processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A first wireless device, comprising:
a processing system that includes processor circuitry and memory circuitry that stores code, the processing system configured to cause the first wireless device to:
transmit an indication of an update to one or more parameters, at least a threshold duration prior to the update, associated with one or more features, one or more generations of a wireless network, one or more modes of operation, or any combination thereof, wherein the indication of the update includes an indication of a time at which the update is to occur relative to a reference point; and
communicate with a second wireless device in accordance with the update to the one or more parameters after the time at which the update is to occur.

2. The first wireless device of claim 1, wherein a difference between the time at which the update is to occur and the reference point is greater than or equal to the threshold duration, wherein the reference point is a time at which the indication of the update is received or is an absolute time reference, or both.

3. (canceled)

4. The first wireless device of claim 1, wherein the indication of the update is transmitted to one or more additional wireless devices, of a plurality of additional wireless devices, that are capable of supporting at least a first generation of the one or more generations of the wireless network, are capable of supporting at least one of the one or more features for which the update is applicable, have enabled at least one of the one or more features for which the update is applicable, support one or more communication links for which the update is applicable, or any combination thereof.

5. The first wireless device of claim 1, wherein transmission of the indication of the update is in accordance with the update being from a plurality of updates defined as critical updates, in accordance with the update being associated with at least a first generation of the one or more generations of the wireless network, in accordance with the update being from a subset of the plurality of updates, in accordance with the update affecting a first plurality of additional wireless devices associated with a multiple BSS identifier (MBSSID) set, in accordance with the update affecting a second plurality of additional wireless devices associated with a cohosted set, in accordance with the update being from one or more updates indicated by the second wireless device, or any combination thereof.

6. The first wireless device of claim 1, wherein the indication of the update is transmitted via one or more bits in a capability information field in a beacon frame, in a probe response frame, or both.

7. (canceled)

8. (canceled)

9. The first wireless device of claim 1, wherein the indication of the update is associated with one or more Association Identifiers (AIDs), from a plurality of AIDs, reserved for indicating upcoming updates.

10. (canceled)

11. The first wireless device of claim 1, wherein the indication of the update is transmitted via an additional frame different than a beacon frame and different than a probe response frame, and wherein the additional frame is transmitted a fixed duration offset from the beacon frame, the probe response frame, or both.

12. (canceled)

13. The first wireless device of claim 1, wherein, to transmit the indication of the update, the processing system is configured to cause the first wireless device to:
transmit a plurality of repetitions of the update until the update occurs or until the first wireless device determines that one or more additional wireless devices of a plurality of additional wireless devices, including at least the second wireless device, have received the indication of the update, wherein the update is applicable to the one or more additional wireless devices of the plurality of additional wireless devices.

14. The first wireless device of claim 1, wherein the processing system is further configured to cause the first wireless device to:
transmit an indication of one or more communication links for which the update is applicable.

15-19. (canceled)

20. The first wireless device of claim 1, wherein the indication of the update includes an indication of one or more first values of the one or more parameters prior to the update, an indication of one or more second values of the one or more parameters after the update, or both.

21. (canceled)

22. (canceled)

23. The first wireless device of claim 1, wherein the threshold duration is in accordance with a capability of each additional wireless device of a plurality of additional wireless devices, including at least the second wireless device, to wake up at least once prior to the time at which the update is to occur, in accordance with a threshold listen interval out of the plurality of additional wireless devices, or any combination thereof.

24-31. (canceled)

32. A first wireless device, comprising:
a processing system that includes processor circuitry and memory circuitry that stores code, the processing system configured to cause the first wireless device to:
receive an indication of an update to one or more parameters, at least a threshold duration prior to the update, associated with one or more features, one or more generations of a wireless network, one or more modes of operation, or any combination thereof, wherein the indication of the update includes an indication of a time at which the update is to occur relative to a reference point; and
communicate with a second wireless device in accordance with the update to the one or more parameters after the time at which the update is to occur.

33. The first wireless device of claim 32, wherein a difference between the time at which the update is to occur and the reference point is greater than or equal to the threshold duration, wherein the reference point is a time at which the indication of the update is received or is an absolute time reference, or both.

34. (canceled)

35. The first wireless device of claim 32, wherein reception of the indication of the update by the first wireless device is in accordance with the first wireless device being capable of supporting at least a first generation of the one or more generations of the wireless network, are capable of supporting at least one of the one or more features for which the update is applicable, have enabled at least one of the one or more features for which the update is applicable, support one or more communication links for which the update is applicable, or any combination thereof.

36. The first wireless device of claim 32, wherein reception of the indication of the update is in accordance with the update being from a plurality of updates defined as critical updates, in accordance with the update being associated with at least a first generation of the one or more generations of the wireless network, in accordance with the update being from a subset of the plurality of updates, in accordance with the update affecting a first plurality of additional wireless devices associated with a multiple BSS identifier (MBSSID) set, in accordance with the update affecting a second plurality of additional wireless devices associated with a cohosted set, in accordance with the update being from one or more updates indicated by the first wireless device, or any combination thereof.

37. The first wireless device of claim 32, wherein the indication of the update is transmitted via one or more bits in a capability information field in a beacon frame, in a probe response frame, or both.

38. (canceled)

39. (canceled)

40. The first wireless device of claim 32, wherein the indication of the update is associated with one or more Association Identifiers (AIDs), from a plurality of AIDs, reserved for indicating upcoming updates.

41. (canceled)

42. The first wireless device of claim 32, wherein the indication of the update is transmitted via an additional frame different than a beacon frame and different than a probe response frame, and wherein the additional frame is received a fixed duration offset from the beacon frame, the probe response frame, or both.

43. (canceled)

44. The first wireless device of claim 32, wherein, to receive the indication of the update, the processing system is configured to cause the first wireless device to:
receive a plurality of repetitions of the update until the update occurs or until one or more additional wireless devices of a plurality of additional wireless devices, including at least the first wireless device, have received the indication of the update, wherein the update is applicable to the one or more additional wireless devices of the plurality of additional wireless devices.

45. The first wireless device of claim 32, wherein the processing system is further configured to cause the first wireless device to:
receive an indication of one or more communication links for which the update is applicable.

46-50. (canceled)

51. The first wireless device of claim 32, wherein the indication of the update includes an indication of one or more first values of the one or more parameters prior to the update, an indication of one or more second values of the one or more parameters after the update, or both.

52. (canceled)

53. (canceled)

54. The first wireless device of claim 32, wherein the threshold duration is in accordance with a capability of each additional wireless device of a plurality of additional wireless devices, including at least the first wireless device, to wake up at least once prior to the time at which the update is to occur, in accordance with a threshold listen interval out of the plurality of additional wireless devices, or any combination thereof.

55-62. (canceled)

63. A method for wireless communications at a first wireless device, comprising:
transmitting an indication of an update to one or more parameters, at least a threshold duration prior to the update, associated with one or more features, one or more generations of a wireless network, one or more modes of operation, or any combination thereof, wherein the indication of the update includes an indication of a time at which the update is to occur relative to a reference point; and
communicating with a second wireless device in accordance with the update to the one or more parameters after the time at which the update is to occur.

64-67. (canceled)

68. The method of claim 63, wherein the indication of the update is transmitted via one or more bits in a capability information field in a beacon frame, in a probe response frame, or both.

69-72. (canceled)

73. The method of claim 63, wherein the indication of the update is transmitted via an additional frame different than a beacon frame and different than a probe response frame, and wherein the additional frame is transmitted a fixed duration offset from the beacon frame, the probe response frame, or both.

74. (canceled)

75. The method of claim 63, wherein transmitting the indication of the update comprises:
transmitting a plurality of repetitions of the update until the update occurs or until the first wireless device determines that one or more additional wireless devices of a plurality of additional wireless devices, including at least the second wireless device, have received the indication of the update, wherein the update is applicable to the one or more additional wireless devices of the plurality of additional wireless devices.

76-93. (canceled)

94. A method for wireless communications at a first wireless device, comprising:
receiving an indication of an update to one or more parameters, at least a threshold duration prior to the update, associated with one or more features, one or more generations of a wireless network, one or more modes of operation, or any combination thereof, wherein the indication of the update includes an indication of a time at which the update is to occur relative to a reference point; and
communicating with a second wireless device in accordance with the update to the one or more parameters after the time at which the update is to occur.

95-98. (canceled)

99. The method of claim 94, wherein the indication of the update is transmitted via one or more bits in a capability information field in a beacon frame, in a probe response frame, or both.

100-103. (canceled)

104. The method of claim 94, wherein the indication of the update is transmitted via an additional frame different than a beacon frame and different than a probe response frame, and wherein the additional frame is received a fixed duration offset from the beacon frame, the probe response frame, or both.

105. (canceled)

106. The method of claim 94, wherein receiving the indication of the update comprises:
receiving a plurality of repetitions of the update until the update occurs or until one or more additional wireless devices of a plurality of additional wireless devices, including at least the first wireless device, have received the indication of the update, wherein the update is applicable to the one or more additional wireless devices of the plurality of additional wireless devices.

107-124. (canceled)
